(19) United States
(12) Patent Application Publication
(10) Pub. No.: US 2022/0134222 A1
(43) Pub. Date: May 5, 2022

(54) DELTA PROPAGATION IN CLOUD-CENTRIC PLATFORMS FOR COLLABORATION AND CONNECTIVITY

(71) Applicant: NVIDIA Corporation, Santa Clara, CA (US)

(72) Inventors: Rev Lebaredian, Los Gatos, CA (US); Michael Kass, San Jose, CA (US); Brian Harris, Austin, TX (US); Andrey Shulzhenko, Troitsk (RU)

(21) Appl. No.: 17/088,490

(22) Filed: Nov. 3, 2020

(51) Int. Cl. A63F 13/355; A63F 13/56; G06T 15/00; G06T 15/08; G06T 15/10

(52) U.S. Cl. CPC A63F 13/355; A63F 13/56; G06T 15/10; G06T 15/08; G06T 15/005

(57) ABSTRACT

A content management system may maintain a scene description that represents a 3D world using hierarchical relationships between elements in a scene graph. Clients may exchange delta information between versions of content being edited and/or shared amongst the clients. Each set of delta information may be assigned a value in a sequence of values which defines an order to apply the sets of delta information to produce synchronized versions of the scene graph. Clients may follow conflict resolution rules to consistently resolve conflicts between sets of delta information. Changes to structural elements of content may be represented procedurally to preserve structural consistency across clients while changes to non-structural elements may be represented declaratively to reduce data size. To store and manage the content, structural elements may be referenced using node identifiers, and non-structural elements may be assigned to the node identifiers as field-value pairs.

### CROSS-REFERENCE TO RELATED APPLICATIONS

This application is related to U.S. Non-Provisional application Ser. No. 16/826,296, titled “Cloud-Centric Platform for Collaboration and Connectivity on 3D Virtual Environments,” filed on Mar. 22, 2020 and U.S. Non-Provisional application Ser. No. 16/538,594, titled “Platform and Method for Collaborative generation of Content,” filed on Aug. 12, 2019. Each of these applications is hereby incorporated by reference in its entirety.

### BACKGROUND

Game engines—such as Unreal Engine, Unity, and CryEngine—have been used to enable users to collaborate in a rudimentary form of content creation within a gaming context. However, traditional game engines are not particularly suitable for collaboratively authoring high quality content of a three-dimensional (3D) world. For example, game engines are typically designed to optimize for fast replication over fidelity and consistency. Thus, each client may receive an estimate of a shared 3D environment that is accurate enough to share and convey a scene or experience. However, high quality collaborative 3D content authoring may require each participant to view a faithful and consistent representation of the shared 3D environment. Additionally—to facilitate the fast replication—game engines provide clients with a simple atomic-level description of the 3D world, which may include object geometry and transforms. However, authoring high-quality 3D worlds may require the exchange of rich descriptions of the world in order to support the fidelity and features required by modern content authoring tools.

The Universal Scene Description (USD) framework allows for a rich description of a 3D world using complex hierarchical relationships between elements in a scene graph. USD was developed and designed for offline development of 3D films for non-interactive entertainment. In a content creation pipeline, authors take turns individually developing content, which when complete may be merged by manually transferring and combining large files that include portions of scene description. Using such a rich description in a system that supports concurrent collaboration and connectivity presents significant challenges to replicating and storing scene elements with fidelity and consistency.

### SUMMARY

The present disclosure relates to approaches for cloud-centric platforms for collaboration and connectivity on 3D virtual environments. Aspects of the disclosure provide for delta propagation in cloud-centric platforms for collaboration and connectivity.

A content management system may maintain a scene description that represents a 3D world using hierarchical relationships between elements in a scene graph. In some respects, clients may exchange delta information between versions of content being edited and/or shared amongst the clients. Each set of delta information may be assigned a value in a sequence of values which defines an order in which to apply the sets of delta information to the scene graph to produce synchronized versions of the scene graph. The clients may each follow conflict resolution rules to consistently resolve conflicts between sets of delta information.

A set of delta information may include changes to structural elements of content and changes to non-structural elements of the content. The changes to structural elements may be represented procedurally to preserve the structural consistency of the content across clients while changes to non-structural elements may be represented declaratively to reduce data size. To store and manage the content, structural elements (nodes) of the content may be referenced using node identifiers (IDs), and non-structural elements may be assigned to the node IDs as field-value pairs, allowing for identification of the proper node even if the node is reparented or renamed. In embodiments, content may be stored using a hierarchy of versions of objects and storage space may be reduced by storing the changes between a child version and a parent version to the child. Further aspects of the disclosure relate to caching versions of objects to efficiently serve content to clients.

### BRIEF DESCRIPTION OF THE DRAWINGS

The present systems and methods for delta propagation in cloud-centric platforms for collaboration and connectivity are described in detail below with reference to the attached drawing figures, wherein:

FIG. 1 is diagram illustrating an example of an operating environment that may be used to collaboratively author shared content, in accordance with some embodiments of the present disclosure;

FIG. 2A illustrates an example of how properties and values of assets of a 3D virtual environment may be defined, in accordance with some embodiments of the present disclosure;

FIG. 2B illustrates an example of how the properties and values of FIG. 2A may be resolved, in accordance with some embodiments of the present disclosure;

FIG. 2C is a block diagram illustrating an example of the use of a data store to create multiple virtual environments, in accordance with some embodiments of the present disclosure;

FIG. 2D is a block diagram illustrating an example of the use of a data store for virtual environment forking, in accordance with some embodiments of the present disclosure;

FIG. 3A illustrates an example of a display of a graphical representation of a 3D virtual environment represented using a scene description, in accordance with some embodiments of the present disclosure;

FIG. 3B illustrates an example of a display in an animation editor of a graphical representation of a 3D virtual environment represented using the scene description of FIG. 3A, in accordance with some embodiments of the present disclosure;

FIG. 3C illustrates an example of a display in in a game engine editor of a graphical representation of a 3D virtual environment represented using the scene description of FIG. 3A, in accordance with some embodiments of the present disclosure;

FIG. 3D illustrates an example of a display in a raster graphics editor of a graphical representation of a 3D virtual environment represented using the scene description of FIG. 3A, in accordance with some embodiments of the present disclosure;

FIG. 4A shows a block diagram illustrating examples of components of an operating environment that implements a publish/subscribe model over transport infrastructure, in accordance with some embodiments of the present disclosure;

FIG. 4B shows a block diagram illustrating examples of components of an operating environment that implements a publish/subscribe model over transport infrastructure that includes a network(s), in accordance with some embodiments of the present disclosure;

FIG. 5 is a block diagram illustrating an example of a flow of information between a content management system and clients, in accordance with some embodiments of the present disclosure;

FIG. 6 is diagram illustrating an example of an operating environment including multiple content management systems, in accordance with some embodiments of the present disclosure;

FIG. 7 is a data flow diagram showing an example of a process for synchronizing versions of content of a 3D virtual environment, in accordance with some embodiments of the present disclosure;

FIG. 8 is a flow diagram showing an example of a method a client may use for updating a synchronized version of content, in accordance with some embodiments of the present disclosure;

FIG. 9 is a flow diagram showing an example of a method a server may use for updating a synchronized version of content, in accordance with some embodiments of the present disclosure;

FIG. 10 is a flow diagram showing an example of a method a system may use for updating a synchronized version of content, in accordance with some embodiments of the present disclosure;

FIG. 11 is a diagram illustrating an example of a structure which may be used by a data store to capture an object representing hierarchical elements, in accordance with some embodiments of the present disclosure;

FIG. 12A is a diagram illustrating an example of versions of an object, in accordance with some embodiments of the present disclosure;

FIG. 12B is a diagram illustrating an example of data storage for versions of an object, in accordance with some embodiments of the present disclosure;

FIG. 13 is a block diagram of an example computing device suitable for use in implementing some embodiments of the present disclosure; and

FIG. 14 is a block diagram of an example data center suitable for use in implementing some embodiments of the present disclosure.

### DETAILED DESCRIPTION

The present disclosure relates to approaches for cloud-centric platforms for collaboration and connectivity on 3D virtual environments. Aspects of the disclosure provide for delta propagation in cloud-centric platforms for collaboration and connectivity.

A content management system may maintain a scene description that represents a 3D world using hierarchical relationships between elements in a scene graph. In some respects, clients may exchange delta information between versions of content being edited and/or shared amongst the clients. Each set of delta information may be assigned a value in a sequence of values which defines an order in which to apply the sets of delta information to the scene graph to produce synchronized versions of the scene graph. When a client sends delta information to a server, the client may wait for the server to provide the value, then apply the delta information according to the value once it is received. While waiting for the value, sets of delta information may be received and applied according to the order. The clients may each follow conflict resolution rules to consistently resolve conflicts between sets of delta information. Using disclosed approaches, a client need not wait for confirmation from the server that a set of delta information has been accepted. Further, a client need not recreate a set of delta information due to the delta information being created between wrong versions of content.

Further aspects of the disclosure provide for creating sets of delta information that capture changes to content that comprises hierarchical elements (e.g., scene description). A set of delta information may include a section defining one or more changes to one or more structural elements of scene description and a section defining one or more changes to one or more non-structural elements of the scene description. Structural elements may correspond to graph nodes of a scene graph, as well as the interconnections shown between the nodes. Non-structural elements may refer to properties and/or values (e.g., field-value pairs) assigned to nodes and/or structural elements. A non-structural element generally may not impact the structure of the scene graph, whereas a structural element may define structure of the scene graph. Structural elements of the content (e.g., defining nodes and/or relationships between nodes) may be represented procedurally such as using one or more commands that may be performed on a version of the content to produce an updated version of the content. This may preserve the structural consistency of the content across clients. Non-structural elements of the content (e.g., defining fields and values of structural elements) may be represented declaratively. This may reduce data sizes as intermediate states between versions need not be recorded.

The disclosure further provides approaches for storing and managing content that includes hierarchical elements. In at least one embodiment, each node of content may have a unique identifier (ID). The unique ID of a node may be assigned to the node upon creation of the node (e.g., in a create command). The unique ID may be used for the node its entire life, whether it be renamed, removed, or re-parented. Structural changes to a node and/or changes and/or assignments of property-value pairs (e.g., fields and/or field values) to the node may be specified using the node's unique ID. In some embodiments, the unique ID may be generated and/or assigned to a node by a client 106 that creates the node. For example, the unique ID (which may more generally be referred to as a node ID) for a node may be a randomly generated 64 or 128-bit number. Thus, to change a field value of a field of a node, a set of delta information may include the node ID, a field ID, and the field value.

In accordance with some aspects of the disclosure, a data store may store and reference structural elements (nodes) of the scene description using the node IDs, and non-structural elements may be assigned to the node IDs as field-value pairs. The field-value pairs may function as key-value pairs, except that rather than a single key-value pair in the data store, key-value pairs may be per-node ID or node. For example, the nodes may be stored in a separate structure or table from the key-value pairs in the data store. When a client refers to a node, the client may reference both the node ID and one or more relevant field-value pairs with the node ID allowing for identification of the proper node even if the node is reparented or renamed.

In further aspects of the disclosure, content may be stored using a hierarchy of versions of objects and storage space may be reduced by storing the changes between a child version and a parent version to the child. Further aspects of the disclosure relate to caching versions of objects to efficiently server content to clients.

While the description primarily provides examples of content that corresponds to virtual environments and three-dimensional (3D) content, disclosed approaches can be applied to a variety of content types (e.g., hierarchical and/or tree or graph-based content).

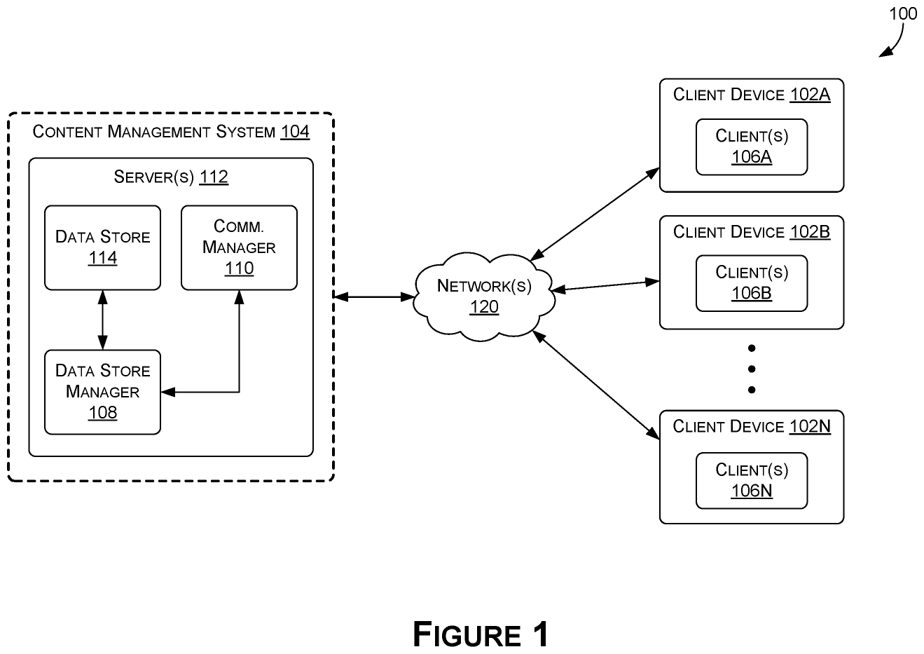

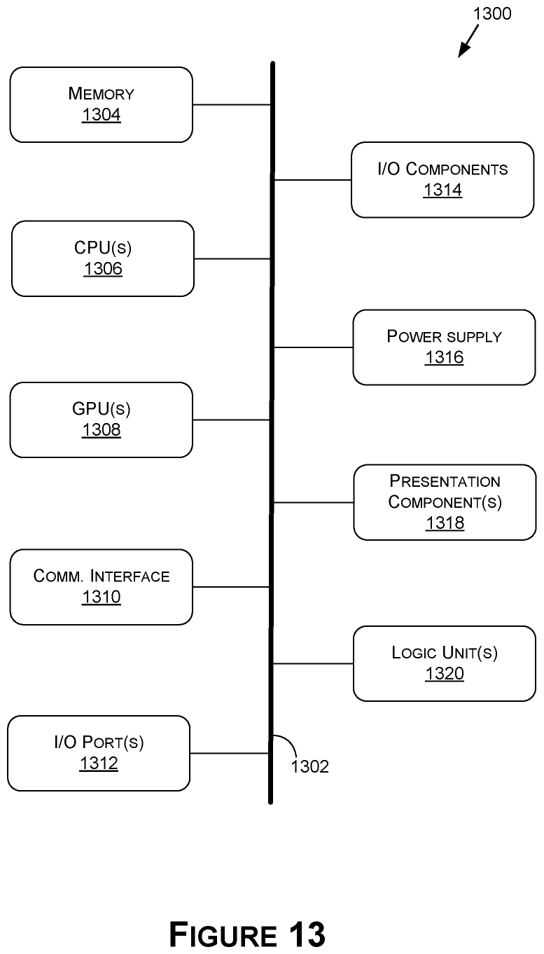

With reference to FIG. 1, FIG. 1 is diagram illustrating an example of an operating environment 100 that may be used to collaboratively author shared content, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. By way of example, the operating environment 100 may be implemented on one or more instances of the computing device 1300 of FIG. 13.

The operating environment 100 may include any number of clients, such as client(s) 106A and 106B through 106N (also referred to as “client(s) 106”) and a content management system 104. These components may communicate with each other via a network(s) 120, which may be wired, wireless, or both. The network 120 may include multiple networks, or a network of networks, but is shown in simple form so as not to obscure aspects of the present disclosure. By way of example, the network 120 may include one or more wide area networks (WANs), one or more local area networks (LANs), one or more public networks such as the Internet, and/or one or more private networks. Where the network 120 includes a wireless telecommunications network, components such as a base station, a communications tower, or even access points (as well as other components) may provide wireless connectivity.

Each client 106 may correspond to one or more applications, software tools, and/or services that can be executed on or using one or more computing devices, such as client devices 102A and 102B through 102N (also referred to as “client devices 102”). The client devices 102 may include different types of devices; that is, they may have different computational and display capabilities and different operating systems. Depending on hardware and software capabilities, the client devices 102 may be used to implement the client(s) 106 as either thick clients or thin clients.

Each client device 102 may include at least some of the components, features, and functionality of the example computing device 1300 described herein with respect to FIG. 13. By way of example and not limitation, any of the client devices 102 may be embodied as a personal computer (PC), a laptop computer, a mobile device, a smartphone, a tablet computer, a smart watch, a wearable computer, a personal digital assistant (PDA), a media player, a global positioning system (GPS) or device, a video player, a server device, a handheld communications device, a gaming device or system, an entertainment system, a vehicle computer system, a remote control, an appliance, a consumer electronic device, a workstation, any combination of these delineated devices, or any other suitable device.

Each client device 102 may include one or more processors, and one or more computer-readable media. The computer-readable media may include computer-readable instructions executable by the one or more processors. The instructions, when executed by the one or more processors, may cause the one or more processors to perform any combination and/or portion of the methods described herein and/or implement any portion of the functionality of the operating environment 100 of FIG. 1 (e.g., to implement the client(s) 106).

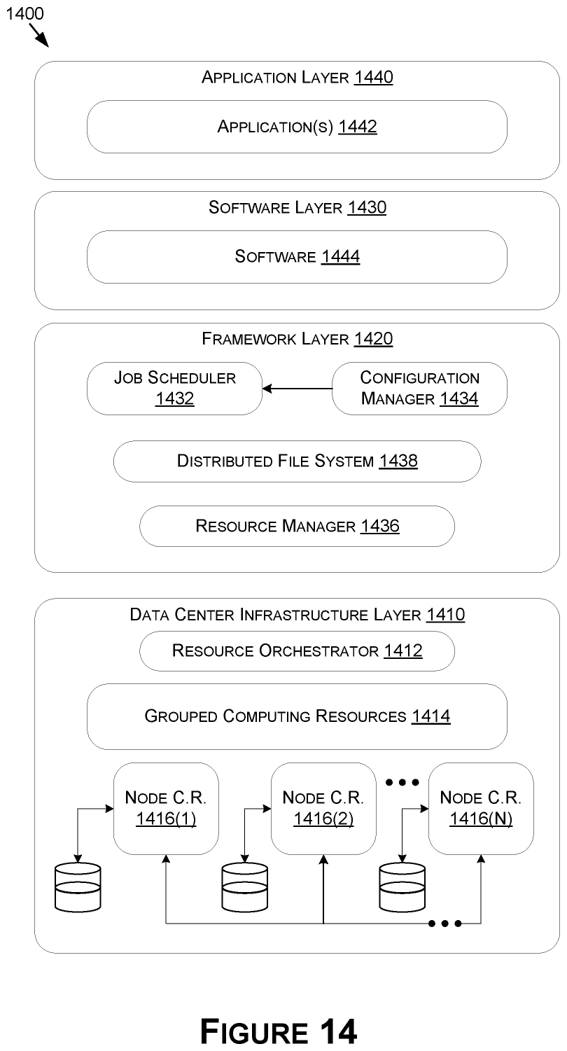

The content management system 104 includes a data store(s) 114, a data store manager(s) 108, and a communications manager(s) 110, which may be implemented on, for example, one or more servers, such as a server(s) 112. Each server 112 may include one or more processors, and one or more computer-readable media. The computer-readable media may include computer-readable instructions executable by the one or more processors. The instructions, when executed by the one or more processors, may cause the one or more processors to perform any combination and/or portion of the methods described herein and/or implement any portion of the functionality of the operating environment 100 of FIG. 1 (e.g., to implement the data store manager 108 and/or the communications manager 110). In at least one embodiment, the content management system 104 may be implemented, at least in part, in the data center 1400 of FIG. 14.

The data store(s) 114 may comprise one or more computer-readable media. For example, the data store(s) 114 may refer to one or more databases. The data store 114 (or computer data storage) is depicted as a single component, but may be embodied as one or more data stores (e.g., databases) and may be at least partially in the cloud. For example, the data store 114 can include multiple data stores and/or databases that are implemented and stored on one or more computing systems (e.g., a datacenter).

The operating environment 100 may be implemented as a cloud-centric platform. For example, the operating environment 100 may be a web-based platform that can be implemented using one or more devices connected and working cooperatively via the network 120 (e.g., the Internet). However, while the operating environment 100 is primarily described in terms of a client-server architecture, different arrangements are contemplated to account for different network architectures, such as peer-to-peer networks, or hybrid network types. Although depicted within the server(s) 112, the data store(s) 114 may be at least partially embodied on any combination of the server(s) 112, the client devices 102, and/or one or more other servers or devices. Thus, it should be appreciated that information in the data store(s) 114 may be distributed in any suitable manner across one or more data stores for storage (some of which may be hosted externally). Similarly, functionality of the data store manager(s) 108, the communications manager(s) 110, and/or the client(s) 106 may be at least partially embodied on any combination of the server(s) 1102, the client devices 102, and/or on or more other servers or devices.

As an overview, the data store(s) 114 of the content management system 104 may be configured to store data representative of assets and metadata used to define one or more 3D environments, such one or more 3D scenes and/or 3D worlds. The data store manager 108 of the content management system 104 may be configured to manage the assets and the metadata in the data store(s) 114, including resolving properties and/or values of 3D virtual environments. The communications manager 110 of the content management system 104 may be configured to manage communications provided by or to the content management system 104, such as over the network 120, and/or communications within the content management system 104.

In at least one embodiment, the communications manager 110 of the content management system 104 may be configured to establish and maintain one or more communications channels with one or more of the client(s) 106. For example, the communications manager 110 may provide a respective bidirectional communications channel(s) to each client 106. In various embodiments, a bidirectional communications channel comprises one or more network sockets (e.g., WebSockets) and/or one or more ports. In embodiments, one or more of the client(s) 106 connects to the server(s) 112 through a port or socket, and communicates with the server(s) 112 using a common Application Programming Interface (API) that enables bidirectional communication (e.g., the WebSockets API) over the bidirectional communications channel(s). In accordance with disclosed embodiments, assets of a virtual environment may be defined in a scene description, which may be in the form of a scene graph comprising properties and values, and/or a language (in textual form) that describes the properties and values according to one or more schemas. Changes to portions of scene descriptions (e.g., textual description) at the server(s) 112 may be replicated to the client(s) 106 over the channel(s), and vice-versa.

The client(s) 106 may include one or more types of applications, software, and/or services, such as, but not limited to: a physics simulation application, an artificial intelligence (AI) application, a global illumination (GI) application, a game engine, a computer graphics application, a renderer, a graphics editor, a virtual reality (VR) application, an augmented reality application, or a scripting application. In embodiments where the applications or services are different from each other, the client(s) 106 may be referred to as “heterogeneous clients.”

As mentioned, the data store(s) 114 of the content management system 104 may be configured to store data representative of assets and metadata used to define one or more elements of 3D environments, such one or more 3D scenes and/or 3D worlds. A content item may refer to an individually identifiable and/or addressable (e.g., via a URI and/or other identifier(s)) asset(s) or element(s) of an asset(s) (and/or version thereof), such as one or more properties or property-value pairs. Elements of an asset may include structural and/or non-structural elements, as described herein. Metadata (e.g., in a JSON) for content items may describe where the underlying data is located, Access Control Lists (ACLs) for which users are allowed to view and/or modify a content item, timestamps, lock and unlock statuses, data type information, and/or other service information. Many of the changes to data in the data store(s) 114 may operate on the metadata as opposed to the underlying data. For example, a copy operation may not be deep, as it may be accomplished by copying the metadata information and creating a link to the same underlying data, such as to fork content as described herein.

Metadata and the underlying data may be stored separately in the data store(s) 114 as they scale differently. In-memory key-value databases may be employed with a metadata database(s) and data database(s). Multiple database instances (e.g., on any number of machines) may be provided for scaling and may include one or more read slaves to better scale read performance by replicating master instances. The data store manager 108 may reference and locate content items and associated metadata in the data store(s) 114 by a Uniform Resource Identifier (URI). In some embodiments, the data store manager 108 may hash a URI to determine location information and to select an appropriate database instance to access. In non-limiting examples, instances may be single threaded with one run per-CPU core.

The data store manager 108 may operate one or more delta servers (e.g., one per metadata instance). A delta server may coalesce or collapse a series of delta changes (e.g., to scene description) into a new version of content, as described herein. For example, the changes may be received from a particular client 106 and may be collapsed into a keyframe version that is shared with other client(s) 106 so that the new incoming client(s) 106 may receive a relatively compact version of the content that reflects the changes.

Examples of Assets

An asset may correspond to data (e.g., 3D data) that can be used with other assets to compose a 3D virtual environment. A “virtual environment” may refer to a virtual scene, world, or universe. Virtual scenes can be combined to form virtual worlds or universes. Each asset may be defined in terms of one or more properties, one or more values of the one or more properties (e.g., key-value pairs with properties being the keys), and/or one or more other assets and/or content items (e.g., via properties and values and/or syntax). Examples of assets include layers, objects (e.g., models and/or model groups), stages (top level or root scene graphs), scenes, primitives, classes, and/or combinations thereof. The assets of a virtual environment may be defined in a scene description, which may be in the form of a scene graph comprising properties and values. Further, in various embodiments, content items of some assets may be described and defined across a number of other assets and/or across a number of files (e.g., of scene description) and/or data structures.

Non-limiting examples of properties and/or values of the properties are those that may specify and/or define one or more portions of geometry, shaders, textures, geometric variations, shading variations, Level-of-Detail (LoD), asset references or identifiers, animations, special effects, timing information, model rigging information, virtual camera information, lighting information, composting information, references (e.g., referred to below with respect to referencing assets) thereto and/or instantiations thereof (e.g., referred to below with respect to instantiated assets). In various examples, properties and/or values of the properties for assets may be time varying, such as by being defined by scripts and/or functions.

Assets may be defined, specified, formatted, and/or interfaced with in accordance with one or more schemas, one or more domain-specific schemas, and/or one or more scene description languages. In non-limiting examples, the schema, format, languages, and/or interfaces (e.g., APIs) may be in accordance with the Universal Scene Description (USD) framework. The data store manager 108 and/or the client(s) 106 (and/or content managers 410, renderers 414, services 412, described herein) may analyze asset definitions of a scene description in order to resolve the properties and values of assets of a 3D virtual environment. Schemas may ascribe meanings to the properties and values of the scene description (e.g., written in textual form using a scene description language), such as (for example and without limitation) any or a combination of: geometry, lights, physics (e.g., for rigid bodies, flexible materials, fluids and gases), materials, rigs, and the way their properties vary over time. Physics parameters may be included for specifying physical properties like mass, inertia tensors, coefficients of friction and coefficients of restitution, with specifications of joints, hinges and other rigid-body constraints. Users may extend a scene graph by adding custom properties embedded in new schemas.

In various examples, an asset(s) definition of a scene description may therein specify and/or define one or more other assets and/or one or more portions (e.g., properties and/or values) of other assets therein (e.g., in a layer). In such examples, an asset may be referred to as a containing asset, or container of the other asset(s), and the other asset(s) may be referred to as a nested asset with respect to the containing asset. For example, a layer may include one or more objects at least partially defined therein. In embodiments, any of the various asset types described herein may be a containing asset and/or a nested asset with respect to another asset. Further, a containing asset may be a nested asset of any number of other containing assets and/or may include any number of nested assets, any of which themselves may be a containing asset of one or more other assets.

Also in various examples, an asset(s) may be specified and/or defined in scene description as an instantiation of one more other assets and/or one or more portions (e.g., properties and/or values) of other assets (e.g., of a class). In such examples, an asset may be referred to as an instantiated asset, or instance of the other asset(s), and the other asset(s) may be referred to as a source asset with respect to the instance asset. In embodiments, any of the various asset types described herein may be a source asset and/or an instantiated asset with respect to another asset. For example, an object may be an instantiation of a class. Further, an instantiated asset may be a source asset of any number of other instantiated assets and/or may include any number of source assets, any of which themselves may be an instantiated asset of one or more other assets. In various embodiments, an instantiated asset may inherit from any number of source assets (e.g., classes). Multiple inheritance may refer to where an instantiated asset inherits from more than one source asset. For example, an object or class can inherit properties and/or values from more than one parent object or parent class. Further, as with other asset types, the parent object or parent class may be defined and resolved across any number of layers, as described herein.

Additionally, one or more properties and/or values of an asset(s) may be defined in a scene description by one or more references to one or more other assets and/or one or more instantiations of one or more other assets (e.g., via properties and values). An asset(s) may include a reference (e.g., an identifier), or pointer, to another asset that incorporates one or more portions of that other asset into the asset. In such examples, the asset may be referred to as a referencing asset and the other asset may be referred to as an incorporated asset with respect to the referencing asset. In embodiments, any of the various asset types described herein may be a referencing asset and/or an incorporated asset with respect to another asset. Further, a referencing asset may be an incorporated asset of any number of other referencing assets and/or may include any number of incorporated assets, any of which themselves may be a referencing asset of one or more other assets.

Various combinations of containing assets, nested assets, instantiated assets, source assets, referencing assets, and/or incorporated assets may be used in scene description to collectively define properties and corresponding values of assets for a 3D virtual environment. According to one or more schemas, these relationships may be defined or specified explicitly via properties and values and/or implicitly from the structure of the scene description. For example, an asset being specified and/or defined as an instantiated asset may cause the asset to inherit one or more properties and/or values from a source asset. Also, an asset being specified and/or defined as an incorporated asset to a referencing asset may cause the referencing asset to inherit one or more properties and/or values from the incorporated asset.

Furthermore, in at least one embodiment, one or more properties of an asset(s) that is inherited from one or more other assets may be defined and/or specified in scene description with an override to the one or more properties from the other asset. An override to a property may, for example, replace or supersede the value(s) of the property and/or the property with a different value(s) and/or property. An override for an asset may be explicitly declared or specified using a property and value according to a syntax or schema of asset descriptions (e.g., in the asset definition), and/or may be implicit from the syntax or schema (e.g., according to where the asset is declared). For example, an assignment of a value to a property in an asset may serve as an explicit override to a value of that property that is inherited from another asset.

In at least one embodiment, a layer may be provided in a scene description of a 3D virtual environment. A layer may contain or group zero or more other asset types such as objects and classes, which in turn may describe values for properties of those and/or other assets. In some examples, each layer may include an identifier that can be used to construct references to the layer from other layers. In some embodiments, each layer corresponds to a respective file (e.g., of scene description) used to represent the layer within the data store 114.

Each layer may be assigned (e.g., by a client, a user, and/or the data store manager 108) a ranking with respect to other layers of a 3D virtual environment. The data store manager 108 and/or the client(s) 106 may use the rankings to resolve one or more properties and/or values of assets of the 3D virtual environment. For example, the data store manager 108 may determine properties and values as a merged view of the assets in one or more of the layers by combining the asset definitions of the scene description in accordance with the rankings. In one or more embodiments, layers may express or define “opinions” on properties and/or values of assets of a composed 3D scene and the data store manager 108 may use the opinion of the strongest or highest ranking layer when combining or merging scene description of multiple layers. In at least one embodiment, the strength of a layer may be defined by a position of the layer in an ordered list or stack of layers. For example, the list or stack may be ordered from strongest layer to weakest layer. Layers may be used to modify properties and/or values of existing assets in scene description without modifying their source in order to change virtually any aspect by overriding it in a stronger layer.

In at least one embodiment, scene description of a virtual environment may be resolved to a tree structure of a transformation hierarchy (e.g., a scene graph). Relationships between layers may be used to change properties and/or values of assets anywhere in the transformation hierarchy by affecting the way one or more aspects of assets of the 3D virtual environment are composed or resolved into the tree structure (e.g., according to the rankings). For example, the objects or other assets within the layers may be included in different leaves of the transformation hierarchy. Use of layers may allow properties and values across objects or other assets in a layer (or group) to be changed. For example, an engine and doors of a car may be represented as different objects in a transformation hierarchy. However, the engine and the doors may both include screws, and layers may be used to permit properties of the screws to be changed no matter where the screws appear in the transformation hierarchy.

Thus, assets of a scene may be defined and described in one or more hierarchies of asset definitions of scene description, which may collectively define properties and values of the assets or elements of a 3D scene. Non-limiting examples of hierarchies include model hierarchies, transformation hierarchies, layer hierarchies, class hierarchies, and/or object hierarchies, one or more of which may be embedded within another hierarchy and/or hierarchy types.

In various examples, the data store manager 108 may analyze the asset definitions of scene description, the metadata, and/or the associated properties and/or values specified by the asset definitions (in accordance with the hierarchies) in order to resolve one or more of the properties and/or values associated with one or more particular assets or elements of a 3D virtual environment. This may include, for example, traversing one or more of the hierarchies, data structures, and/or portions thereof, to resolve the properties and values. For example, the data store manager 108 may access specified references to assets and/or instantiations thereto defined by the scene description in order to traverse a hierarchy.

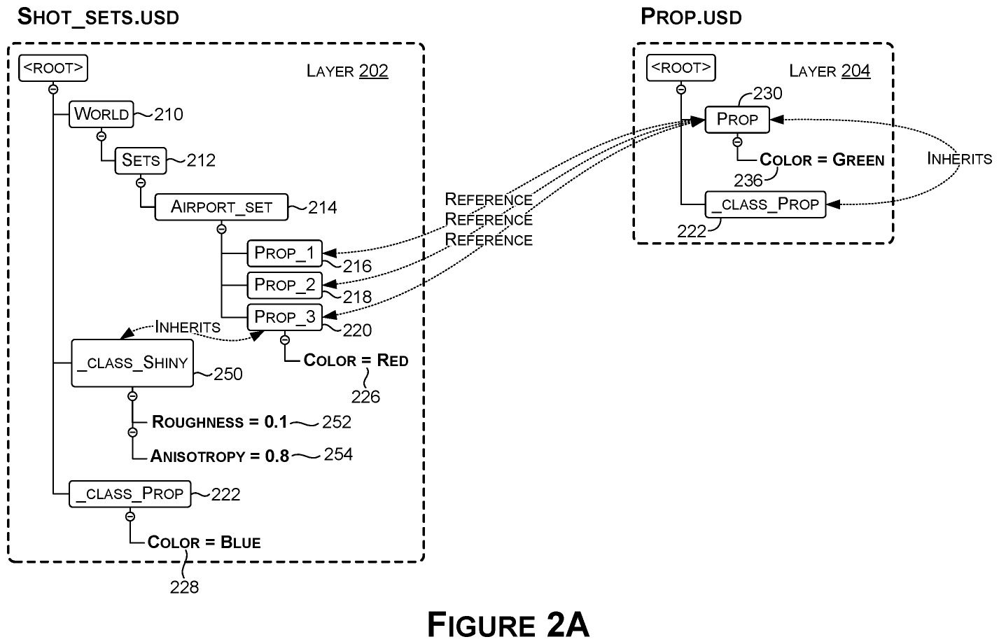

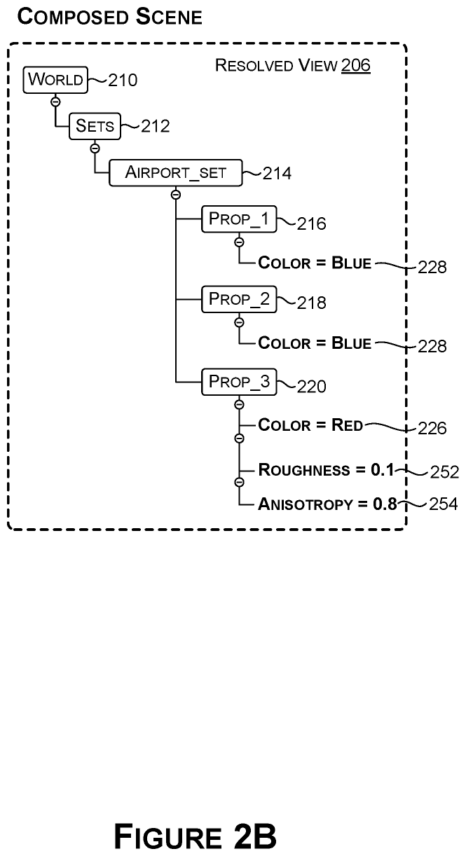

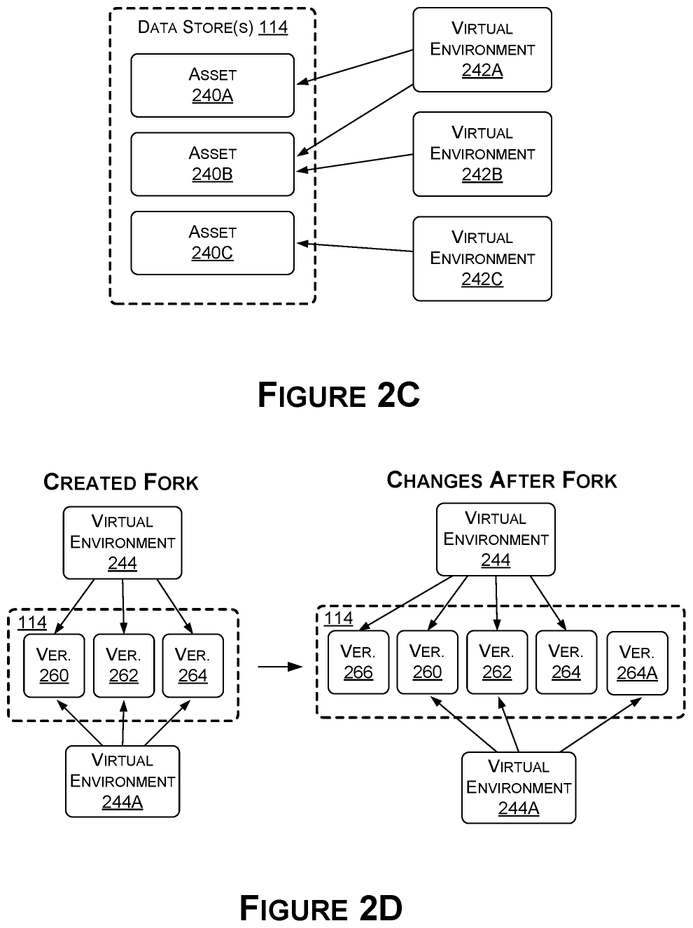

Referring now to FIG. 2A and FIG. 2B, FIGS. 2A and 2B illustrate an example of how properties and values of assets of a 3D virtual environment may be defined and resolved, in accordance with some embodiments of the present disclosure. Elements, or assets, of FIG. 2A may be referred to unresolved elements, or assets of scene description, and elements, or assets, of FIG. 2B may be referred to as resolved, or composed elements, or assets of the scene description. FIG. 2A shows a layer 202 and a layer 204 which may be defined according to a scene description of a 3D virtual environment, and FIG. 2B shows a resolved view 206 of the 3D virtual environment. The scene description of the 3D virtual environment may include additional assets, such as additional layers, which are not shown in FIGS. 2A and 2B. The layer 202 may include definitions for assets 210, 212, 214, 216, 218, 220, 216, 218, 220, 222, and 250, and the layer 204 may include definitions for the assets 230, 216, and 222.

In the example shown, the assets 216, 218, and 220 may each be defined in scene description as referencing assets to the asset 230 of the layer 204, which may be an incorporated asset with respect to the assets 216, 218, and 220. Thus, the assets 216, 218, and 220 may each inherit properties and/or values from the asset 230. The scene description for the asset 230 may include a property-value pair 236 assigning a color property to green. However, the asset 230 may be defined as an instantiated asset of the asset 222, which is a source asset with respect to the asset 230 (e.g., a class). Thus, the asset 230 may inherit a property-value pair 228 from the asset 222 assigning the color property to blue. The layer 202 may be ranked as a stronger layer than the layer 204. Thus, the property-value pair 228 may override the property-value pair 236 for the asset 230. As such, the assets 216, 218, and 220 may each also inherit the property-value pair 228 from the asset 230. However, the scene description for the asset 220 may include a property-value pair 226 which may override the property-value pair 228. As such, the data store manager 108 may resolve the asset 216 as having the property-value pair 228, the asset 218 as having the property-value pair 228, and the asset 220 as having the property-value pair 226, as shown in the resolved view 206.

Additionally, the asset 220 may be defined as an instantiated asset of the asset 250, which is a source asset with respect to the asset 220 (e.g., a class). Thus, the asset 220 may inherit property-value pairs 252 and 254 from the asset 250 and the property-value pair 228 from the asset 222 (which is overridden in this example) providing an example of multiple inheritance where an instantiated asset may have multiple source assets. For example, the asset 220 is an instantiation of multiple classes. Another asset (not shown), may also inherit from a different set of classes that may or may not include the asset 250 and/or the asset 222. For example, the asset 220 may represent a propeller of an airplane and both the asset 220 and an asset representing an airport hangar could inherit from the asset 250 so they each include properties of a shiny metal surface. Thus, in various embodiments, property inheritance may operate along a transform hierarchy, as well as from multiple classes.

The layers 202 and 204 may be defined by scene description in terms of scene graphs, which resolve to a scene graph of the resolved view 206, as shown (e.g., by merging the scene graphs according to resolution rules). A resolved view may be composed from any number of layers and/or constituent scene graphs. Some properties and values of a scene graph may define or declare structure of the scene graph by declaring objects, or nodes, of the scene graph, and/or relationships between the nodes or objects. These properties and values may be referred to as structural elements of the scene description. Examples of structural elements that define or declare relationships include a structural element(s) that declares or define an instantiation of a class or other asset, a reference to another object, or asset, a variant of a scene element or object, and/or an inheritance relationship between objects, or assets. Generally, in FIG. 2A the visually depicted graph nodes, as well as the interconnections shown between nodes, may each correspond to a structural element. An example of a structural element is a declaration of the asset 222 in the layer 202 of FIG. 2A. Further examples of structural elements may be a declaration of the reference relationship between the assets 216 and 230 that is indicated in FIG. 2A, as well as declarations of the inheritance relationships between the asset 250 and the asset 220 and between the asset 230 and the asset 222.

Other properties and values may define or declare fields and values that belong to the objects, or nodes, of the scene graph. These properties and values may be referred to as non-structural elements of the scene description. An example of a non-structural element is a declaration of the property-value pair 228 for the asset 222 in the layer 202 of FIG. 2A. Generally, in FIG. 2A the elements that are attached to the visually depicted graph nodes may each correspond to a non-structural element.

While the resolved view 206 of FIG. 2B shows resolved elements—such as assets (or objects) and corresponding property-value pairs—resulting from each unresolved element depicted in the layers 202 and 204 of FIG. 2A, the client(s) 106, the content management system 104, and/or other component may determine resolved elements on an as needed or as desired basis (by resolving and/or traversing one or more portions or subsets of the scene description) and may not necessarily resolve each element from the unresolved scene description. Generally, a resolved view or scene description may refer to a state of a 3D virtual environment that is manifested or composed from the scene description. One or more elements of a resolved view may be what is rendered and/or presented for the 3D virtual environment.

In embodiments, a client 106 and/or other component of the operating environment 100 may resolve portions of scene description that are available and/or active for composition. For example, a client 106 may resolve the portions, or content items, of the scene description that the client 106 is subscribed to and may not use unsubscribed portions, or content items for resolution or composition of one or more portions of a resolved view. This may result in different clients 106 using different resolved views of the same shared scene description. For example, if the client 106A is subscribed to the layers 202 and 204, the client 106A may use the resolved view 206 of FIG. 2B. However, if the client 106B is subscribed to the layer 202 and not the layer 204, the resolved view used by the client 106B may be different. For example, the assets 216, 218, and 220 may no longer inherit from the asset 222 so that the color property of the assets 216 and 218 no longer resolve to blue, as in FIG. 2B. To further the example, the client 106B may be subscribed to another layer (not shown) that provides a different definition for the asset 230 than the layer 204, resulting in different properties and values for the assets 216, 218, and 220. Additionally, that other layer might also be subscribed to by the client 106A, but is not manifested in the resolved view 206 because it has a lower ranking than the layer 204. With the layer 204 unavailable and/or inactive for the client 106B, one or more elements that were previously overridden from the other layer may now be manifested in the resolved view for the client 106B.

Referring now to FIG. 2C, FIG. 2C is a block diagram illustrating an example of the use of a data store to create multiple virtual environments, in accordance with some embodiments of the present disclosure. In the example of FIG. 2C, assets 240A, 240B, and 240C (or more generally content items) described in the data store 114 may be referenced by scene description for different virtual environments 242A, 242B, and 242C. For example, the asset 240A may be used in both of the virtual environments 242A and 242B. As an example, the asset 240B may be defined in at least some scene description of the virtual environment 242B and referenced by or instanced from at least some scene description of the virtual environment 242A, as described herein. For example, a scene description of a layer may be shared between scene descriptions of multiple virtual environments.

Referring now to FIG. 2D, FIG. 2D is a block diagram illustrating an example of the use of the data store 114 for virtual environment forking, in accordance with some embodiments of the present disclosure. For example, a virtual environment 244 may be forked to create a virtual environment 244A. Forking virtual environments into multiple copies may be a relatively inexpensive (computationally) operation. For examples, forking a virtual environment may be implemented by creating a new source control branch in a version control system. References to one or more asset version in the data store 114 may be copied from the virtual environment 244 to the virtual environment 244A, as indicated in FIG. 2D. Thus, to fork the virtual environment 244A from the virtual environment 244, corresponding asset names for the virtual environment 244A may be configured to point to asset versions 260, 262, and 264 of the virtual environment 244. In some embodiments, a Copy-on-Write (CoW) resource-management scheme may be employed so that asset versions that are copied are shared initially amongst the virtual environment 244 and the virtual environment 244A, as indicated in FIG. 2D. Once forked, scene description of the virtual environments 244 and/or 244A may be modified to differentiate the virtual environments such as though overrides, additional asset definitions, and/or changes made to asset versions. One or more changes made to the virtual environment 244 may be made without impacting the virtual environment 244A and vice versa. For example, if a user modifies an asset corresponding to the asset version 264 in the virtual environment 244A, an asset name for the virtual environment 244A may be updated to point to a new asset version 264A while retaining the asset version 264 for the virtual environment 244, as shown in FIG. 2D. If a user adds a new asset to the virtual environment 244, the asset name for the virtual environment 244 may be created and may point to a corresponding asset version 266, as shown in FIG. 2D. Although not shown, if the new asset is declared in an asset that has shared asset version between the virtual environments 244A and 244, that change to the asset may also result in a new asset version for that asset (as the virtual environments 244A and 244 may each be represented using a number of interrelated assets and/or files). In some embodiments, any of these asset versions may be subject to being coalesced, as described herein. One or more of the client(s) 106 may request (e.g., at the direction of a user or algorithm) that a version of the 3D virtual environment and/or one or more particular content items thereof be persistently stored on the content management system 104 to guarantee recoverability.

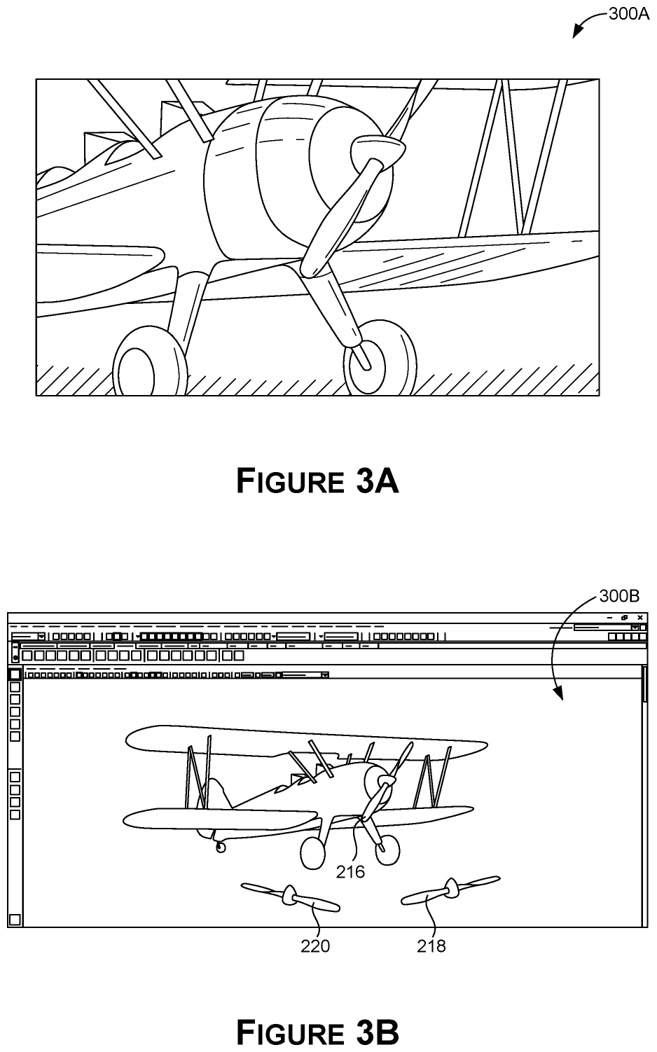

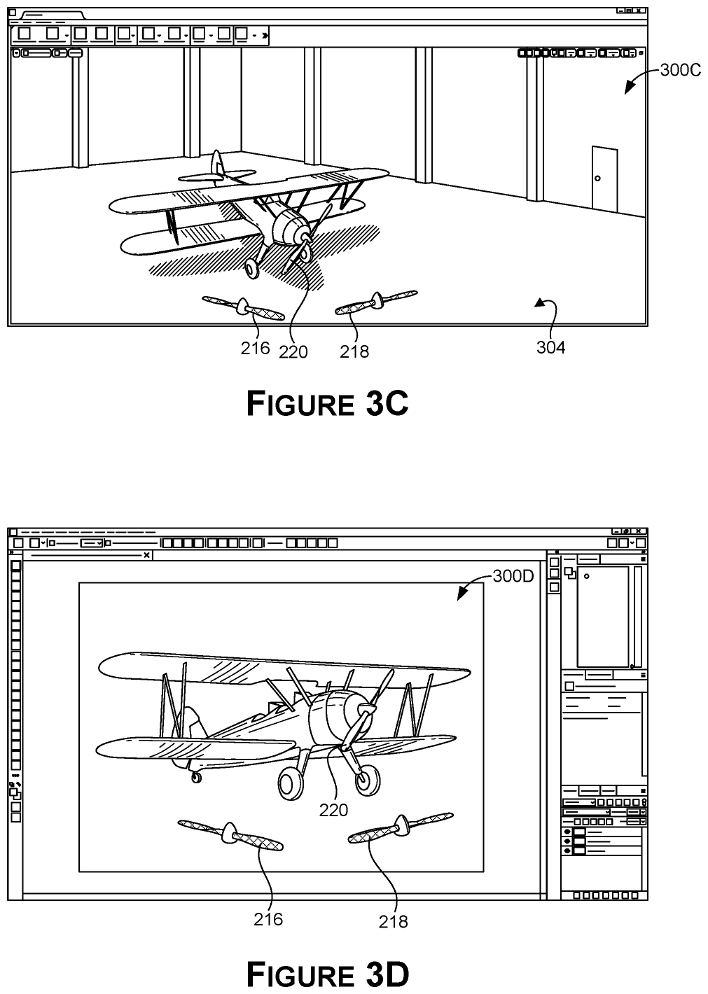

Referring now to FIGS. 3A-3D, FIGS. 3A-3D illustrate examples of displays of graphical representations of a 3D virtual environment, in accordance with some embodiments of the present disclosure. In accordance with embodiments of the present disclosure, displays 300A, 300B, 300C, and 300D in FIGS. 3A-3D may be presented by any combination of the client(s) 106 and/or client devices 102 of FIG. 1. As examples, all of the displays 300A, 300B, 300C, and 300D may be presented by a same client 106 and/or a same client device 102 (e.g., in different windows and/or on different monitors). As further examples, the displays 300A, 300B, 300C, and 300D may each be presented by a respective client 106 and/or a respective client device 102.

The displays 300A, 300B, 300C, and 300D in FIGS. 3A-3D are renderings of a same scene description of a 3D virtual environment. In particular, the displays 300A, 300B, 300C, and 300D may each correspond to a same scene definition or description and version of the 3D virtual environment that is shared by the client(s) 106 via the content management system 104. However, the graphical representations of the 3D virtual environment may appear different within each client for various possible reasons. For example, a client 106 and/or the data store manager 108 may deactivate and/or activate one or more descriptions of assets and/or portions thereof in the scene description of the 3D virtual environment. As another example, one or more descriptions of assets and/or portions thereof in the scene description of the 3D virtual environment may be unavailable for asset resolution due to lack of permissions for a client and/or user. When resolving assets of the 3D virtual environment, the data store manager 108 and/or the client 106 (and/or content manager 410) may exclude unavailable and/or inactive portions of the scene description (e.g., when traversing hierarches defined by the scene description). This may result in different property and value resolutions that are reflected in the graphical representations.

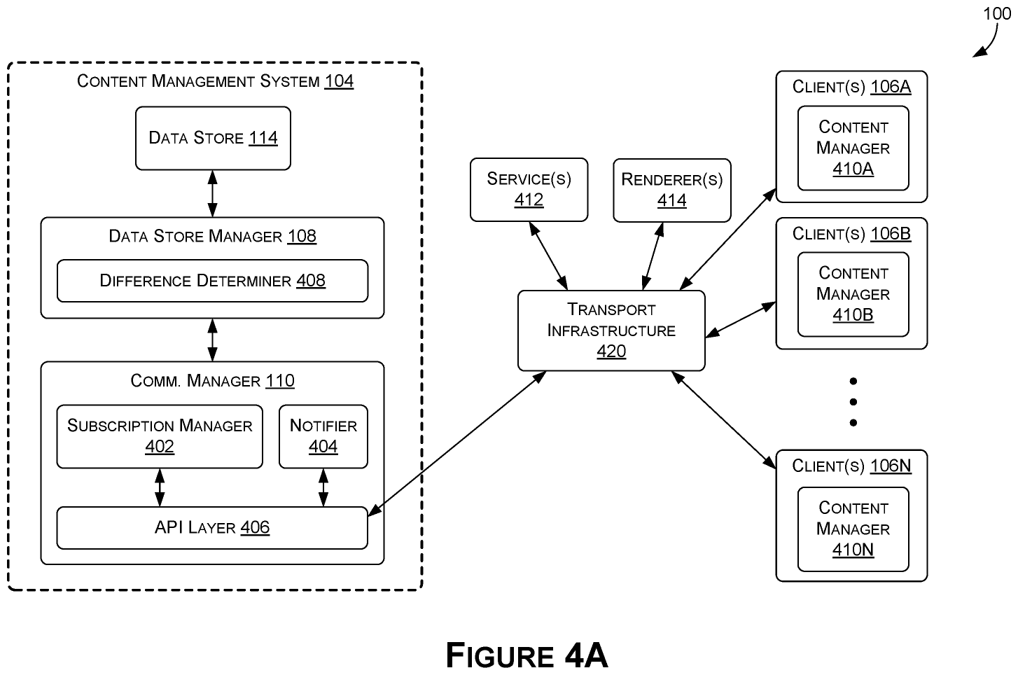

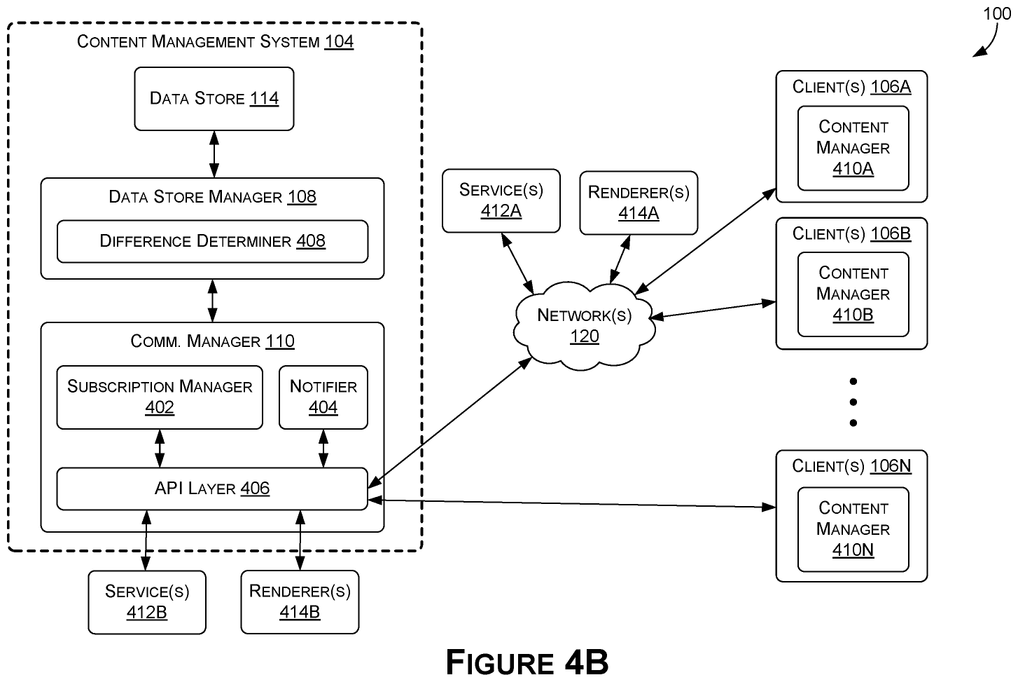

To illustrate the forgoing, the scene description of the 3D virtual environment of FIGS. 3A-3D may correspond to the scene description of FIG. 2A that includes definitions for the layers 202 and 204 and one or more additional layers. One or more additional layers, not indicated in FIG. 2A, may include additional at least portions of asset definitions for additional assets, such as an asset 304 corresponding to the ground, and other environmental assets represented in the display 300C. For the display 300D and/or the display 300B, a portion of scene description corresponding to the layer(s) may be unavailable and/or inactive, and therefore the corresponding properties and values may not be represented in the display 300D and/or the display 300B. For the display 300A, scene description for all layers associated with the 3D virtual environment may be active. In some examples, any combination of the displays 300A, 300B, 300C, or 300D may correspond to a video stream from a renderer 414 of the content management system 104 as described with respect to FIGS. 4A and 4B, or may correspond to frames rendered at least partially by a corresponding client 106.

Using containing assets, nested assets, instantiated assets, source assets, referencing assets, incorporated assets and/or overrides in scene description may enable the content management system 104 to provide rich descriptions of complex scenes capable of supporting the fidelity and features required by modern content authoring tools. For example, a single representation of a 3D virtual environment may be provided that can capture all of the various scene information that may be consumable by any of the various client(s) 106, even where individual client(s) 106 are only capable of consuming a particular subset and/or format of that information. Rich ways of communicating data between the client(s) 106 may be provided, such as by enabling non-destructive editing of data by the client(s) 106 (e.g., through overrides and activation/deactivation of content items), and enabling edits to assets to propagate to other assets via scene description hierarchies and references. Additionally, the representation of the assets may be compact in memory at the data store 114 by allowing for reuse of the underlying data.

However, such a rich representation of 3D virtual environments can impose significant limitations on network bandwidth and computations needed to resolve properties and values. For example, conventional software and systems that support rich representations of 3D virtual environments—such as USD—were developed and designed for offline development of 3D films for non-interactive entertainment. Content authors conventionally take turns individually developing aspects of content, which when complete may be merged by manually transferring and combining large files that include portions of scene description. Finally, the composite scene description may be run through a pipeline to resolve properties and values and render the 3D content into a video for viewing.

In this context, collaborative editing, interaction, and/or viewing of dynamic 3D virtual environments across devices and systems has not previously been possible, nor contemplated, for rich representations of 3D virtual environments. For example, the size of the data that is conventionally transferred when merging portions of a scene description is often prohibitively large enough to result in transfer times that make real-time or near-real time applications impossible or impractical. Additionally, the complexity in the scene description that is conventionally analyzed when resolving assets is often prohibitively high enough to result in processing times that further make real-time or near-real time applications impossible or impractical when combining portions of scene description to form a 3D virtual environment.

### Publish and Subscribe Model and Incremental Updates to Content

In accordance with aspects of the disclosure, a publish/subscribe model may be operated by the data store manager 108 (one or more database servers) to provide one or more portions of scene description of a 3D virtual environment to the client(s) 106. Synchronization through the content management system 104 may be incremental with only changes to the scene description being published to subscribers. Incremental updates may allow real-time interoperation of content creation tools, renderers, augmented and virtual reality software and/or advanced simulation software of the client(s) 106 and/or within the content management system 104. In embodiments, clients may publish and subscribe to any piece of content (e.g., content item) for which they have suitable permissions. When multiple client(s) 106 publish and/or subscribe to the same or an overlapping set of content, a shared virtual environment may be provided with updates from any one of the client(s) 106 reflected to the others at interactive speeds.

Use cases include, but are not limited to: design reviews for product design and architecture; scene generation; scientific visualization (SciVis); automobile simulation (e.g., AutoSIM); cloud versions of games; virtual set production; and social VR or AR with user-generated content and elaborate worlds. For example, a graphics editor (e.g., Photoshop®) can be connected to the content management system 104 to add a texture to an object in a virtual scene, and a computer graphics application or animation tool (e.g., Autodesk Maya®) can be connected to the content management system 104 to animate that object (or a different object) in the virtual scene.

As described herein, a subscription to content may refer to a subscription to a portion of scene description that describes the content. Changes, or deltas, of the content may be with respect to that scene description portion. For example, data representative of content that is exchanged within the operating environment 100 may be in the form of scene description—such as via scene description language in a textual form, and/or via corresponding data structures and/or scene graph components—and/or in the form of difference data that may be used to reconstruct modified scene description portions from versions thereof.

Each client 106 and/or user may provide a request to the content management system 104 for a subscription to one or more identified assets of a 3D virtual environment and/or one or more identified portions thereof (e.g., “content” or “content items”). Based on the request, the content management system 104 may publish to the client 106 updates to the subscribed to content. A subscription by a client 106 to one or more assets and/or one or more portions thereof may serve as a request to at least be notified in the future that changes are available at the content management system 104 for the corresponding content. For example, a publication that is based on a subscription may include a notification that changes are available for the corresponding content and/or may include data representative of one or more portions of the corresponding content. Where a notification identifies that changes are available for the corresponding content, the client 106 may request data representative of the corresponding content and/or one or more portions of the corresponding content based on the notification. In response to that request, the client 106 may receive the requested data.

In general, in response to being provided a change to a content item, a client 106 and/or content manager 410 may make another change to that content item, and update the shared description to include the other change; make a change to another content item, and update the shared description to include the change to the other content item; use the content item including any change in some type of operation that does not cause another change to the content item; render the content item/asset; display the content item/asset; and/or update a graphical representation corresponding to the content item/asset.

In order to take any actions regarding changes to resolved properties and/or values of a scene description, the client 106 and/or content manager 410 (and similarly services 412 or renderers 414) may need to perform one or more portions of property and/or value resolution described herein to account for any changes made to the scene description. For example, a change to a portion of scene description of one content item may propagate to any number of other content items (e.g., in other layers) through the various relationships described herein, such as overrides, inheritance, references, instantiations, etc. This resolution may be different for different client(s) 106 (or services) depending upon which content items are active and/or available for property and value resolution at that client 106.

Using approaches described herein, when one or more client(s) 106 make changes to a portion of the scene description of the 3D virtual environment, other client(s) 106 may only receive content and/or notifications of the changes for portions of the scene description that are subscribed to by those client(s) 106. Thus, content of the scene description and changes thereto may be served on as needed or as desired basis, reducing the amount of data that needs to be transferred across the operating environment 100 for collaborative editing and/or other experiences for the client(s) 106 that may occur over the network 120. Also in some embodiments, rather than completely rerunning property and value resolution for scene description at the client 106, the content manager 410 may update the property and value resolution only with respect to the updated content item and/or changes to the content item. For example, differences may be identified and if those differences involve a relationship with another content item, and/or an override, corresponding updates may be made to property and value resolution data. However, unaffected properties and values may be retained and reused without having to resolve the entire local version of the scene graph.

In further aspects of the present disclosure, updates to content received from and/or provided to the client 106 may include the changes—or differences—between versions of a scene description portion(s) that corresponds to the content (e.g., requested and/or subscribed to content). For example, rather than transferring entire descriptions of assets and/or files of the 3D virtual environment to the content management system 104, each client 106 may determine data representative of differences between versions of content (e.g., describing added, deleted, and/or modified properties and/or values), and provide that data to the content management system 104. The difference data may be determined such that the data store manager 108 and/or other client(s) 106 are able to construct the updated version of the content (e.g., which may be based on edits made using the client 106) from the difference data. Thus, using disclosed approaches, rather than transferring entire copies of assets of the scene description when changes occur to the scene description, only information needed to effectuate those changes may be transferred, reducing the amount of data that needs to be transferred across the operating environment 100 for collaborative editing and/or other experiences for the client(s) 106 that may occur over the network 120.

Referring now to FIG. 4A, FIG. 4A shows a block diagram illustrating examples of components of the operating environment 100 that implements a publish/subscribe model over a transport infrastructure 420, in accordance with some embodiments of the present disclosure. In FIG. 4A, the communications manager 110 of the content management system 104 includes a subscription manager 402, a notifier 404, and an API layer 406. The data store manager 108 of the content management system 104 includes a difference determiner 408. The content management system 104 may also include one or more services 412, which may include or refer to one or more microservices, and one or more renderers 414. In some embodiments one or more of the renderers 414 and/or one or more of the services 412 may be a client 106. Thus, discussion of a client 106 may similarly apply to a renderer 414 and/or a service 412.

In at least one embodiment, the client(s) 106, the service(s) 412 and/or the renderer(s) 414 may each interface with the content management system 104 over the transport infrastructure 420 through the API layer 406 (e.g., comprising sockets such as Websockets). The transport infrastructure 420 may include any combination of the network 120 of FIG. 1 and/or inter-process communication of one or more server and/or client devices. For example, in some embodiments, the transport infrastructure 420 includes inter-process communication(s) of one or more of the client device 102A, the client device 102B, the client device 102, one or more of the server(s) 112, and/or one or more other server and/or client devices not shown.

In any example, the API layer 406, any other portion of the content management system 104, one or more of the clients 106, one or more of the services 412, and/or one or more of the renderers 414 may be implemented at least partially on one or more of those devices. The transport infrastructure 420 may vary depending upon these configurations. For example, a client device 102A could host the content management system 104 and the client 106A (and in some cases multiple clients 106). In such an example, a portion of the transport infrastructure 420 used by the local client 106A may include inter-process communication of the client device 102A. If a non-local client 106 is also included in the operating environment 100, another portion of the transport infrastructure 420 used by the non-local client 106 may include at least a portion of the network(s) 120.

As a further example, FIG. 4B shows a block diagram illustrating examples of components of an operating environment that implements a publish/subscribe model over the transport infrastructure 420 that includes the network(s) 120, in accordance with some embodiments of the present disclosure. In this example services 412A and services 412B may correspond to services 412 of FIG. 4A and renderers 414A and renderers 414B may correspond to renderers 414 of FIG. 4A. The services 412A and renderers 414A may be on one or more client and/or server devices and communicate with the content management system 104 over the network(s) 120. The services 412B and renderers 414B may share a client and/or server device with the content management system 104 and communicate with the content management system 104 over inter-process communication(s). Similarly, the client(s) 106A and the client(s) 106B may be on one or more client and/or server devices and communicate with the content management system 104 over the network(s) 120. The client(s) 106N may share a client and/or server device with the content management system 104 and communicate with the content management system 104 over inter-process communication(s).

The clients (or services or renderers) may use the API layer 406 to, for example, query and/or modify the data store 114, to subscribe to content of a 3D virtual environment, to unsubscribe from content of a 3D virtual environment, and/or to receive or provide updates to content of a 3D virtual environment or notifications thereof. The subscription manager 402 may be configured to manage the subscriptions of the client(s) 106 to the content. The notifier 404 may be configured to provide updates to content of a 3D virtual environment and/or notifications thereof to the client(s) 106 (e.g., using the subscription manager 402. The difference determiner 408 may be configured to determine differences between versions of content, such as between a current or base version(s) of the content and an updated version(s) of the content. In various embodiments, this may be similar to or different than operations performed by a content manager 410, and the notifier 404 may or may not forward those differences to any subscribing client(s) 106.

The services 412 may perform, for one or more 3D virtual environments, physics simulation, global illumination, ray-tracing, artificial intelligence operations, and/or other functions, which may include view-independent simulation or other functionality. In various examples, the services 412 may carry out any combination of these functions by operating on and/or updating the scene description(s) of the 3D virtual environment(s) using the data store manager 108. For example, properties and values may be analyzed and/or updated by one or more of the services 412 to effectuate physics operations, global illumination, ray-tracing effects, artificial intelligence, etc. Changes made by the services 412 may be to the scene description that is shared between the client(s) 106, and may or may not operate through the publish/subscribe model.

Each renderer 414 may perform, for one or more client(s) 106, one or more aspects of rendering a 3D virtual environment stored in the data store(s) 114. The rendered data may comprise, for example, frames of the 3D virtual environment, which may be streamed to a client 106 for viewing thereon. In various embodiments, a renderer 414 may perform cloud rendering for a client 106 that is a thin client, such as a mobile device. Where a client 106 is a VR client and/or an AR client, a renderer 414 may render a video stream (e.g., RGB-D) that is wider than the field-of-view of the camera, and may also transmit supplemental depth and hole-filling data from nearby viewpoints. During a period when the client 106 has stale data, the client 106 may reproject the stale data from the new viewpoint using the depth and hole-filling data to create appropriate parallax.

One or more of the renderers 414 and/or renderers integrated into a client 106 may exploit hardware-accelerated ray-tracing features of GPUs. Independent passes may be used for specular, diffuse, ambient occlusion, etc. In addition, interactive full path tracing may be supported for a more accurate result. A renderer may make use of multiple GPU's on a single node as well as multiple nodes working together. For multi-node rendering, each node may subscribe—via the subscription manager 402—to a same 3D virtual environment and/or content items thereof and render an appropriate tile. A control node may be used for timing and compositing the results. Synchronization among the nodes may be achieved using a message-passing service of the content management system 104.

In FIGS. 4A and 4B each of the client(s) 106 are shown as including a respective content manager 410. For example, the client 106A includes a content manager 410A, the client 106B includes a content manager 410B, and the client 106N includes a content manager 410N. The content managers 410A, 410B, and 410N are also referred to herein as “content managers 410.” While each of the client(s) 106 are shown as including a content manager 410, in some examples one or more of the client(s) 106 may not include a content manager 410. For example, where a client 106 is a thin client (and/or is a client that does not locally process description data) the client 106 may not include a content manager 410. As further examples, different content managers 410 may include different subsets or combination of functionality described herein.

The subscription manager 402 may be configured to manage subscriptions of the client(s) 106 to the content of one or more 3D virtual environments. To subscribe to one or more content items, a client 106 may provide a request (e.g., API call) to the communications manager 110 of the content management system 104 that identifies the content (e.g., via the API layer 406). For example, the client 106 may provide an identifier of each item of content to request a subscription(s) to that content.

In some embodiments, a subscription to a content item (e.g., a layer or other asset type) by a client 106 may correspond to a subscription to particular files and/or resources of scene description (e.g., particular scene description portions) of a 3D virtual environment in the data store 114. For example, an identifier of content may comprise a file identifier and/or a file path of the files or resources. In some examples, content items and/or resources thereof may be identified within the operating environment 100 using a URI which may be in the form of a text string—such as a Uniform Resource Locator (URL)—which may also be referred to as a web address. Another example includes a Uniform Resource Name (URN).

Communication between the client(s) 106 and the content management system 104 may use a protocol encoded in JavaScript Object Notation (JSON) format, but other suitable formats may be used. Commands (e.g., to the API layer 406) may be supported for a client 106 to authenticate, create a file and/or asset, upload the contents of a file and/or asset, read a file and/or asset, receive a list of the contents of directories and/or assets (or resources or content items), and change permissions on files, resources, and/or content items (including locking and unlocking for writing). The communications manager 110 of the content management system 104 may also support commands to implement a message-passing mechanism for any additional communication desired among connected client(s) 106 and/or the services 412.

In at least one embodiment, a request to read a content item may serve as a subscription request for the content item. For example, when reading a file and/or resource (e.g., scene description portion), there may be an option for a client 106 to subscribe to future changes. In response to the request by the client 106, the subscription manager 402 may register a subscription(s) to the identified content and the data store manager 108 may provide the content to the client 106. After the content is provided to the client 106, the client 106 may receive all updates published to the content in the form of deltas. In some cases, providing the content to the client 106 may include providing all of the scene description of the identified content. In other examples, providing the content may include synchronizing data between the client 106 and the data store manager 108 that is representative of one or more portions of the description of the content. Synchronization may be used where the client 106 already includes data corresponding to the content (e.g., in a local cache), such as an older version of the content and/or a portion of the content (e.g., from a prior session). In such examples, the difference determiner 408 may be used to determine what portions of the content to send to the client 106 and/or difference data between client and server versions of one or more content items. In any example, the response to the read request may provide the client 106 with a contemporary or latest version of the content being shared amongst client(s) 106.

A non-limiting example of a request for a subscription may comprise: {‘command’: ‘read,’ ‘uri’: ‘/project/asset.usdc’, ‘etag’: −1 ‘id’: 12}. In this example, an identifier of the content may comprise the URI value ‘/project/asset.usdc.’ An identifier of the request may comprise the id value of 12. Further, the etag value of −1 may indicate a latest version of the content available for collaboration amongst the client(s) 106. In other examples, the etag value may serve as a unique version identifier of the content (e.g., for other message types). A non-limiting example of a response to the request for the subscription may comprise: {‘status’: ‘LATEST,’ ‘id’: 12}+<asset content>. In this example, <asset content> may be data representative of one or more portions of the requested content (e.g., scene description and/or difference data). Other requests and responses may follow a similar format.

A client 106 may create, delete, and/or modify content of the 3D virtual environment. Updating a file and/or resource may be done incrementally by the client 106 supplying a delta or difference for the content. This may, for example, occur with respect to a local copy or version of the content. For example, where the client 106 received one or more items of content from the content management system 104 (e.g., in association with one or more subscriptions), the content manager 410 at the client 106 may track such edits made to the content (e.g., scene description portion). Examples of changes include adding any element to, deleting any element from, and/or modifying any element of scene description, such as properties and/or values therein. For example, an edit may change a value of a property in content, add a new property and/or value to content, etc. Such edits may create, delete, or modify containing assets, nested assets, instantiated assets, source assets, referencing assets, incorporated assets, overrides, and/or definitions of such relationships used to collectively define properties and corresponding values of the 3D virtual environment. For example, a user may add or change an override value to a property in a layer and/or other asset definition, and that change may propagate in property value resolution to any impacted assets (e.g., by overriding a value in another asset or layer even where the client 106 is not subscribed to that other content).

The content manager 410 of the client 106 may track all changes that a client 106 makes to a given content item and/or resource. For example, the content manager 410 may track multiple edit operations performed by a user and/or in software using the client 106. Based on the changes, the content manager 410 may construct a message(s) to send to the content management system 104 that includes data representative of the changes. In various examples, the content manager 410 determines differences between a version of the content item(s) received from the content management system 104, and a version of the content item(s) that includes the edits or changes (e.g., a list of the changes with timestamps). Data representative of these differences may be included in the message(s) rather than the entire content item(s).

In some examples, the difference data may represent one or more property-values pairs of an updated version of an asset procedurally, such as using one or more commands that may be performed on a version of the asset(s), such as a create command, a delete command, a modify command, a rename command, and/or a re-parent command with respect to one or more property-values pairs of the scene description (e.g., one or more structural elements and/or non-structural elements) that may be executed in sequence to construct the updated version of the asset(s). The difference data may also represent and/or indicate a sequence in which the commands are to be executed (e.g., via timestamps or listing them in sequence). In various examples, one or more of the commands may be or may include the same commands executed by the client 106 that provided the difference information and/or a user of a client device to locally modify the content. Also, the sequence may correspond to and/or be the same sequence in which commands were executed by the client 106 and/or entered by a user of a client device.

Additionally or alternatively, the difference data may represent one or more property-values pairs of the updated version of the asset declaratively, such as using updated property-value pairs, new property-value pairs, and/or deleted property-value pairs between the version and the updated version. In various examples one or more property-values pairs of the updated version may be defined procedurally with respect to the previous version of the asset, whereas one or more other property-values pairs of the updated version may be defined declaratively. As an example, structural elements of a scene graph (e.g., defining nodes and/or relationships between nodes) may be represented procedurally, whereas non-structural elements of the scene graph (e.g., defining fields and values) may be represented declaratively.

For example, on demand, the content manager 410 may construct a delta (diff) file for each content item (e.g., layer) that describes any changes made since the corresponding local representation was last synchronized with an external representation. In examples, a user may drag an object, creating a sequence of changes to the position values of the object. The content manager 410 may only send messages to the content management server 104 to reflect some of the states of the content—or may send all of the changes. In either case, the messages may be sent periodically or as available, such as to achieve a predetermined frame or update rate (e.g., about every 30 milliseconds for 30 frames per second) for content updates to the client(s) 106 (a single message may in some embodiments describe multiple states or versions of changes to content). The content manager 410 of a client 106 may generate, transmit, and apply delta files to and from an external source (e.g., the content management system 104), such as to bring a local representation(s) of content into correspondence with a remote and shared representation(s).

A message from a client 106 to the content management system 104 that edits or modifies a content item (e.g., a layer) may identify as an update command. Responses from the content management system 104 to an update command or a read command from a client 106 may include a unique version identifier (e.g., an etag value). Deltas, or differences, determined by the content manager 410 of the client 106 may be relative to a specific version identifier (which may be included in an update message). If a delta arrives at the content management system 104 and it is relative to a version identifier which is no longer current, the content management server 104 may reject the update. This may be considered an error condition, and in order for a client 106 to recover from this error condition, the client 106 may update an internal representation of the content item(s) to a most current version (e.g., through synchronization) or may receive the most current version. The content manager 410 may then construct a new delta(s) relative to that latest version (e.g., etag). An update command may then be provided that include the differences relative to the latest version.

In at least one embodiment, in order to avoid the possibility of race conditions with other processes trying to update the same content item, a client 106 may request a lock on content (e.g., an asset and/or corresponding file or resource) using a lock command. While holding a lock, a client 106 may stream updates to the content management system 104 without having to wait for any acknowledgment. The lock may, in some embodiments, serve as a guarantee that no other process could have modified the content in between the updates. A client 106 may also unlock the content using an unlock command. In some examples, conflicting updates from different client(s) 106 may be accepted and resolved by the data store manager 108.

When the communications manager 110 of the content management system 104 receives an incremental update for a client 106, it may, using the subscription manager 402, directly forward the update (e.g., the message and/or difference data) to all other client(s) 106 (and in some embodiments the services 412 or renderers 414) subscribed to the corresponding content. Using this approach, update messages do not need to be modified before distribution. This may reduce latency and allow the content management system 104 to support a large numbers of client(s) 106 and with fast update rates.

The data store manager 108 may keep track of all updates to each content item (e.g., file or resource) in a list. The difference determiner 408 may periodically coalesce a base or original version of the content and a series of delta updates from one or more client(s) 106 into a new version of the content. For example, the difference determiner 408 may use the data from the client(s) 106 to locally reconstruct one or more versions of the content item(s). Differences to a same content item(s) may be received from multiple client(s) 106 and may be combined with a previous shared version of the content item(s) at the content management system 104 to determine and/or create a new version of the content item(s) (e.g., a shared version). If a client 106 performs a read on content that has not yet been coalesced, it may receive a base version of the content and a series of deltas (created by one or more of the services 412 and/or client(s) 106) that the client 106 can apply to the base content to reconstruct the latest version. The difference determiner 408 may run at lower priority than the process of the data store manager 108 that tracks updates to the content—using spare cycles to coalesce when it can.

In various examples, creating a new version of the content item(s) may include coalescing a history of differences, or changes, made to the content item(s). The coalesced data may be stored in a file and/or resource representative of the version of the content item(s) and/or the 3D virtual environment. However, determining a new version of the content item(s) and/or the 3D virtual environment may not necessarily include coalescing the history of differences. For example, in some embodiment, particular versions of content items and/or properties or values thereof (e.g., a latest shared version) may be derived or identified by the difference determiner 408 from an analysis of the difference data (e.g., relative to a particular version of the content).

Coalescing the history of differences (e.g., using corresponding timestamps) may occur periodically and be used to persistently store and access versions of content, as well as to reduce storage size. Difference data may be discarded in order to conserve storage space. In some embodiments, one or more of the client(s) 106 may request (e.g., at the direction of a user or algorithm) that a version of the 3D virtual environment and/or one or more particular content items be persistently stored on the content management system 104.

In at least one embodiment, the functionality of the content mangers 410 may be built into a plug-in for one or more of the client(s) 106. However, one or more aspects of the functionality of a content manager 410 may also be integrated, at least partially, natively into one or more of the client(s) 106 and/or a host operating system or service, or other local or cloud-based software that may be external to the client 106. Implementing a content manager 410 at least partially as a plug-in to a client 106 is one suitable to integrating a wide variety of game engines, 3D modeling and animation packages, paint programs and AR/VR libraries into the operating environment 100 without necessarily having to modify the native code. For example, these plug-ins may be used to allow the software to inter-operate with each other using live updates passed back and forth through the content management system 104, which acts as a hub.

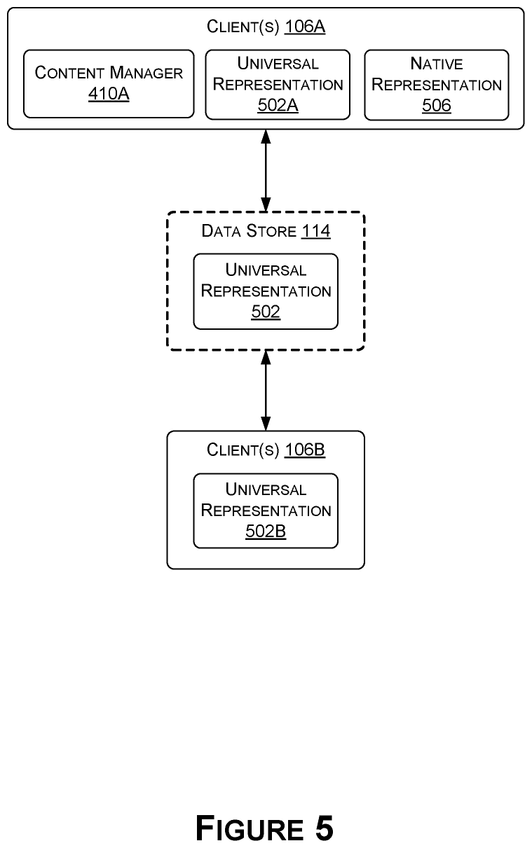

In various examples, a content manager 410 may enable a legacy content creation tool that was not specifically developed for use with the shared scene description format, the APIs, and/or the content management system 104. An example is described with respect to FIG. 5, which is a block diagram illustrating an example of a flow of information between a content management system and clients, in accordance with some embodiments of the present disclosure.

In examples, the content manager 410A that is associated with the client 106A may establish a mirrored relationship between a universal representation 502A at the client 106A and a corresponding universal representation 502 in the data store 114 of the content management system 104 (e.g., so that the content they represent is synchronized). In embodiments where the universal representation 502 is incompatible with the client 106A, the content manager 410A may additionally synchronize a native representation 506 that is useable by the client 106A. For example, the native representation 506 may be a native internal representation of the client 106A with the universal representation 502A comprising a corresponding description format or scene description language that may be shared amongst other client(s) 106 and/or the content management system 104 (e.g., USD scene description). The content manager 410B associated with the client 106B may also establish a mirrored relationship between a universal representation 502B at the client 106B and the corresponding universal representation 502 in the data store 114 of the content management system 104. In this example, the client 106B may be capable of natively using the universal representation 502B.

For this example, assume the display 300B of FIG. 3B corresponds to the client 106B and the display 300C of FIG. 3C or 300D of FIG. 3D corresponds to the client 106A. If a user performs an operation to change the scene description at the client 106B that corresponds to the display 300B, the content manager 410B may make a corresponding modification to the local shared universal representation 502B. If live updating is enabled, the content manager 410B may publish the delta(s) to the content management server 104 (e.g., through the API layer 406). If the subscription manager 402 determines the client 106A is subscribed to the same content, the content manager 410A may receive the delta. The content manager 410A may make the corresponding change to the local version of the shared universal representation 502A, and mirror or propagate that change to the native representation 506 of the client 106A. As a result, users of the client(s) 106A and 106B may both see the scene update live with respect to the displays 300B and 300C or 300D based on the changes made by the user of the client 106B. In embodiments, the content managers 410 may receive and/or display updates from other users and/or the services 412 as they happen, at a predetermined interval or rate, and/or as desired or specified.

While this particular example may involve different users on different client devices 106, in other examples, one or more of the client(s) 106 may be used on a same machine. In this way, a user may use each client 106 according to its capabilities, strengths, and/or the user's preferences. Where multiple client(s) 106 operate on a common client device within the operating environment 100, the client(s) 106 may in some embodiments operate on a common representation of content that is compatible with the content management system 104 (e.g., the universal representation 502A), rather than each retaining and managing separate copies. Similar concepts may be applied across machines on local networks, etc. Various embodiments are contemplated, such as where a content manager 410 acts as a master for managing communications of multiple client(s) 106 with the content management system 104 (or managing native representations), or where each content manager 410 communicates with the content management system 104 and with other content managers 410.

Additionally, one or more users of the client(s) 106 may not actively participate in content authoring or may not participate in a conventional sense. In examples where a client 106 is an AR client or a VR client, the client 106 and/or an associated client device 102 may determine a camera transform based on an orientation of the client device 102 and publish (e.g., by a content manager 410) a description of a camera with that transform to the shared description of a 3D virtual environment managed by the content management system 104. In an example use case, another client 106 (e.g., on a desktop computer or device with a fully-featured GPU) and/or a renderer 414 may subscribe to the camera and render the scene viewable by the camera or otherwise based on that subscribed to content. The resulting render may then be streamed (e.g., over a local WiFi network) to the AR or VR client 106 and displayed on the client device 102 (and/or to one or more other client(s) 106). Using approaches described herein, any number of users using any number of devices or client(s) 106 may simultaneously view a shared virtual world with mobile or other low powered devices, without being limited by the restricted rendering power on any individual device.

Similar to the camera example, for VR applications, an avatar may be posed based on the position of the VR headset and/or controllers. The content management system 104 and the content managers 410 may provide bidirectional replication so that the VR user's avatar and/or view is reflected to all subscribers, AR, VR and non-AR or VR (e.g., across heterogeneous client(s) 106). Further, disclosed embodiments enable tools developed for particular client(s) 106 (e.g., procedural tools) to operate as agents or services that impact the shared 3D virtual environment with changes that are reflected on unsupported clients. As an example, a game engine may include a visual scripting tool. Once a client 106 that supports the tool is subscribed to the shared 3D virtual environment, the service may be provided to all connected client(s) 106 that are subscribed to impacted content. The visual scripting tool may, for example, be triggered when a particular object enters a given bounding box or satisfies some other condition. That condition(s) may be satisfied by changes to the shared 3D virtual environment caused by a different client 106 than the client 106 hosting the tool. For example, a user or algorithm of the other client 106 may move the object into that bounding box, the movement may be published to the content management system 104, and may be broadcast to the client 106 that hosts the tool, thereby triggering a script. The tool may thus make changes to the scene, publish them to the content management system 104, and the effects may appear at interactive speeds to all subscribing client(s) 106. It may therefore appear that the execution engine of the tool is natively integrated into each subscribing client 106.

A further example of tool that may become an agent or service is a constraint satisfaction tool. A constraint satisfaction tool may provide a constraint engine that understands and enforces relationships among doors, windows, walls, and/or other objects. If a client 106 comprising the tool is subscribed to a shared 3D virtual environment, constraint satisfaction may be provided for all subscribed client(s) 106. If one client 106 moves a wall, the client 106 comprising the tool may recognize any constraint violations and may make and publish resultant changes to the placement of the windows, doors, and/or other objects, as examples.

While the scene description used by the content management system 104 may support a high level of generality, this may introduce challenges to the performance of updates across the client(s) 106. For example, a change to content may impact other content through containing assets, nested assets, instantiated assets, source assets, referencing assets, incorporated assets, and/or overrides. Thus, property and value resolution may impose a significant burden on this process. In accordance with embodiments of the present disclosure, a content manager 410 of a client 106 (and/or the content management system 104) may mark or designate one or more content items (e.g., a layer, an asset, a property, a file, a resource) for fast-updates. Such a designation from a client 106 may serve as a promise that the content item(s) will not include changes that impact one or more aspects of property value resolution and/or may restrict the content item(s) from including such changes. A similar designation may be made by the data store manager 108 by determining one or more updates meets these criteria (e.g., an update is only to one or more existing property values).

In embodiments, such restricted changes may include structural changes to the scene description of a 3D virtual environment (e.g., to hierarchical relationships between assets), examples of which may include creating or deleting primitives or relationships in the content item(s). Other requirements may be that the content item (e.g., layer) is the most powerful (e.g., highest priority) for defining those properties in property value resolution, and/or that the content item(s) contains only values for a fixed set of properties of fixed types. By restricting the changes and/or characteristics of one or more content items, property value resolution may be avoided and/or simplified in propagating changes to the content items across the operating environment 100. For example, values of properties may be directly updated using pre-allocated storage. This approach may be useful in various scenarios, such as for physics simulation where transforms may be updated from a specialized physics application or service (e.g., the service 412 and/or a content manager 410).

Lazy Loading

In at least one embodiment, a portion of scene description for a content item that is received by the client(s) 106 (e.g., a subscribed to content item) may include references to one or more other portions of scene description for incorporation into the content item (in addition to properties and values of the content item). These referenced portions may correspond to other content items and may be referred to as payloads. A payload may be an incorporated asset, as described herein, but in some embodiments not all incorporated assets may be payloads. For example, a payload may be a type of incorporated asset and in some examples may be defined or specified as a payload in the scene description. In embodiments, the content manager 410 of a client 106 may analyze a received scene description portion of a content item, identify one or more references to payloads, and determine whether or not to request the corresponding portion(s) of content from the content management system 104 using the reference(s). For example, the content manager 410 may determine whether to read and/or subscribe to the referenced content, which itself may include additional references. This may be used, for example, to reduce bandwidth requirements by reducing the amount of data transferred to the client 106, to manage the memory footprint of a scene so that it does not become too large at the client 106, and/or to load only the representations that are necessary for a desired display and/or use of the content. In some embodiments, other types of incorporated assets that are not payloads may be automatically provided to the client 106 due to being referred to in a subscribed to referencing asset, or may be automatically requested and/or subscribed to by the client 106 when the client 106 identifies the reference in content of the referencing asset.

In some cases, the content item may include metadata for one or more of the references and the content manager 410 may analyze the metadata to determine whether or not to request or subscribe to the additional content. Examples of metadata include a location for the payload (e.g., a corresponding object) in the 3D virtual environment, a type of data (e.g., content item and/or asset) included in the payload, a storage size of the payload or a size of object within the 3D virtual environment, a Level-of-Detail associated with the payload, a variant of a scene element or object associated with the payload, etc. Metadata may in some examples comprise properties and/or values in the description of the content item that are associated with the payload.

As an example, a reference may correspond to a 3D object of a 3D virtual environment rendered on the display 300C of FIG. 3C. A content manager 410 may analyze a bounding box corresponding to the display 300C to determine whether the 3D object is visible to the camera. When the 3D object is outside of the bounding box, the content manager 410 may determine not to request that payload from the content management system 104. Additionally or alternatively, the content manager 410 may determine that the 3D object is far enough away from the camera in the virtual environment that it does not need to be loaded and/or displayed. As a further example, the metadata of the payload may identify the type of content included in the payload, and the content manager 410 may determine the client 106 is not capable of or interested in displaying that type of content. Using this approach, portions of content items may be received and loaded by the client(s) 106 on demand. For example, this approach may be used not only for the initial versions of content received by the client(s) 106, but also for updates to the content items. As an example, a content manager 410 may determine not to request updates for certain payloads.

Meta-Network Implementations

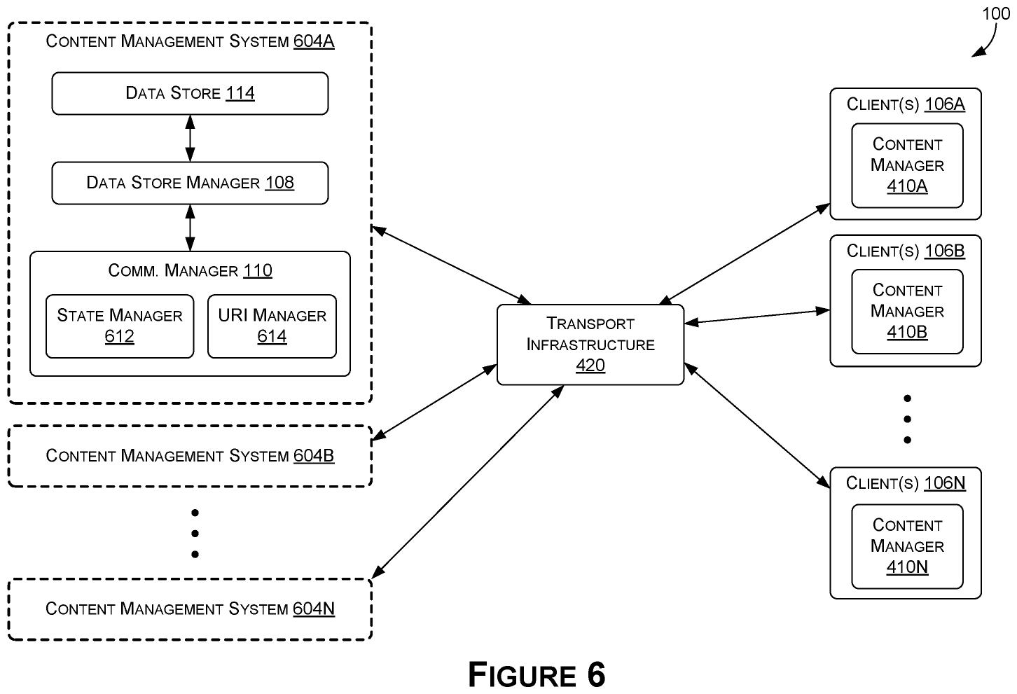

Referring now to FIG. 6, FIG. 6 is diagram illustrating an example of an operating environment including multiple content management systems, in accordance with some embodiments of the present disclosure. In the example of FIG. 6, the operating environment 100 includes any number of content management systems 604A and 604B through 604N (also referred to as “content management systems”). One or more of the content management systems 604 may correspond to the content management system 104. In examples, one or more of the content management systems 604 may be different from one another in or more respects, such as by only allowing for scene description portions of 3D virtual environments to be read by the client(s) 106.

As shown in FIG. 6, one or more of the content management systems 604 may include a state manager 612, and/or a URI manager 614, as shown in the content management system 604A. In some embodiments, using state managers 612, and/or URI managers 614, the content management systems 604 may operate as web-like services, such as to store, generate and serve up content to the client(s) 106.

Each client 106 may connect to a respective content management system 604 through a standard port which is managed by a communications manager 110. Each content item (e.g., file or resource) or portion thereof within the data store 114 may have an associated URI, such as a URL, within the operating environment 100. The client 106 may use the URI to reference the corresponding scene description portion in messages to the content management system 604 (e.g., in read requests, subscription requests, update requests, in other commands, etc.). The URI manager 614 may identify the portion of the scene description that corresponds to the URI and respond to messages from the client 106 accordingly, such as by including data representative of one or more portions of the requested content in a response, updating the corresponding content, etc. In at least one embodiment, the scene description that is provided to the client(s) 106 and maintained in the data store 114 may include the URIs in references for any accessible content item within 3D virtual environments (e.g., payloads, incorporated assets, etc.).

In various examples, the data representative of one or more portions of the requested content may be stored in a different content management system 604 and/or an external data store system than the system the received the request. The URI manager 614 may look up and retrieve a URI associated with that other content management system 604 and/or external data store system and provide the URI in the response. The client(s) 106 may then use that URI to retrieve the data representative of one or more portions of the requested content from the appropriate system. Thus, some client requested content may be stored by the system that receives the request, while other client requested content may be stored by a different system, where the client is provided with the means to retrieve that content (e.g., a URI). As a further example, the system that receives a request for content may retrieve that content from another system using the URI and provide the content to the client(s) 106 in the response. As an additional example, the system that receives a request for content may notify the other system of the request using the URI and that other system may provide the content to the client(s) 106 in the response.

Also in various examples, one or more of the content management systems 604 may use a content delivery network (CDN) that may implement a caching service. The caching service may intercept one or more requests and serve content to the client(s) 106 without necessarily querying backend server(s).

The URIs within a particular content item may correspond to content stored in any number of the content management systems 604 and/or other systems. A client 106 and/or a content manager 410 may use a name resolution system, such as a Domain Name System (DNS), to resolve the URI to an address—such as an Internet Protocol (IP) address—so that corresponding messages are routed over the network 120 to the appropriate content management system 604 and/or server.

In at least one embodiment, the URI manager 614 comprises a HyperText Markup Language (HTML) server and the URIs comprise URLs. The URLs may be within hyperlinks within a content item (e.g., a scene description file). A client 106 may trade a URL for the appropriate portion of content, similar to how an HTTP server allows a client to trade a URL for HTML. For example, a DNS server may be used to resolve the URL to the address of an appropriate content management system 604 that includes corresponding content.

In various implementations, unlike HTTP, the operating environment 100 implements a fundamentally incremental, difference-based protocol. As a result, each content management system 604 may include a state manager 612 to maintain state with client(s) 106 and/or web sessions. To do so, the state manager 612 may implement functionality of a WebSocket server, a REpresentational State Transfer (REST) Hooks server, a WebHooks server, a Pub-Sub server, or other state-based management solution. In embodiments, a bidirectional stateful-protocol may be used. For example, sessions between the client(s) 106 and the content management systems 604 may be implemented over persistent WebSocket connections. States that are maintained (e.g., logged and tracked) by the state manager 612 for connections to a content management system 604 may include those of authentication, as well as the set of subscriptions for the publish/subscribe model and their corresponding version identifiers (e.g., etags). The state manager 612 may be implemented across one or more servers 112 and may hand off and/or assign jobs or tasks to various servers and/or instances within a same or different content management system 604 (e.g., for load balancing purposes). This may include the state manager 612 passing any of the various state data associated with the job to those servers.

Approaches described herein may be used to enable a high performance and practical true 3D Internet. The traditional Internet is fundamentally two-dimensional (2D) and stateless. When something changes regarding a webpage, that page is completely reloaded. This works because 2D webpages are typically small in size and are not complicated in nature. However, a 3D virtual environment may be highly complex and large. Integrating such content into traditional Internet architectures for 2D webpages may result in prohibitively long load times for dynamic 3D content with large file transfers and processing times.

For decades, the computer graphics community has tried to integrate 3D content into conventional Internet architectures for 2D web pages. Early attempts included Virtual Reality Modeling Language (VRML) in 1994 and the Web3D consortium in 1997. More recent examples include Khronos Group standards like WebGL, WebVR and GL Transmission Format (glTF). After all of this time and concerted effort, 3D web technologies still suffer from minimal adoption. This may be due to the limited performance of these solutions along with low visual quality due in part to primitive representations of 3D content.

However, in accordance with disclosed embodiments, by using stateful connections to the content management systems 604, in combination with incremental updates to content, name resolution, and rich descriptions of 3D virtual environments, a high performance and practical foundation for a true 3D Internet may be realized. Additionally, in various embodiments, interactive experiences between users and clients may be facilitated across different systems and 3D virtual environments, and across different interaction engines that may facilitate user interactions with 3D content using vastly different and potentially incompatible rules and software. For example, content and interactions may be shared across game engines and 3D virtual environments, as well as other non-game oriented engines. A hyperlink in a scene description portion of a content item may reference an entire 3D virtual environment (e.g., a top level reference to all scene description of a 3D virtual environment), such as a USD stage and/or a scene graph, which may be hosted by a different content management system 604. The software may handle a link and/or the corresponding content based on the manner in which the link is specified in the scene description (e.g., via metadata, instructions, indicators, context, etc.).

As a further example, the link may refer to a content item or 3D virtual environment that is hosted by a different content management system 604 and embedded within another 3D virtual environment (e.g., for concurrent display and/or interoperability). Additionally, such links may be used by the client 106 and/or an external application or service to load one or more portions of a 3D virtual environment within the client 106. For example, a user may click on a link within content of a web browser, an email, a display of a file system, or within another application or service, and the software may in response cause the 3D content to be loaded and/or displayed within that software or another application or service.

Delta Propagation of Hierarchical Elements

As described herein, in at least one embodiment, deltas, or differences, determined by the content manager 410 of the client 106 may be relative to a specific version identifier (which may be included in an update message). If a delta file arrives at the content management system 104 and it is relative to a version identifier that is no longer current, the content management system 104 may reject the update. This may be considered an error condition, and in order for a client 106 to recover from this error condition, the client 106 may update an internal representation of the content item(s) to a most current version (e.g., through synchronization) or may receive the most current version. The content manager 410 may then construct a new delta(s) relative to that latest version (e.g., etag). An update command may then be provided that include the differences relative to the latest version.

While this approach may be sufficient in many embodiments, in some cases it may introduce latency, as after sending an update to the content management system 104, a client 106 may need to wait for a confirmation that the update was applied before safely sending a subsequent update. Additionally, as the content manager 410 of the client 106 may construct a new delta(s) when a version identifier is no longer current, computing resources used to construct and transmit the old delta(s) may be wasted. These issues may be exacerbated if the client 106 has a high latency connection to the content management system 104. Locking may be used to mitigate these issues by allowing the content manager 410 to send updates prior to receiving confirmations on prior updates. However, locking may use manual locks/unlocks by the content managers 410 of the clients 106, introducing complexity in implementing the locking mechanism. Further, locking prevents more than one client from updating a content item (e.g., scene) at the same time. This may be suitable when one client 106 is modifying the content and the other client(s) 106 are in a “view-only” mode.

In accordance with at least one embodiment of the disclosure, updates (e.g., sets of delta information) to content from the content managers 410 of the clients 106 may be assigned values that define an order in which the updates are to be applied by the clients 106. Using the values, the content manager 410 of the clients 106 may each derive the same order in which to apply any particular update, so that synchronized versions of the content (e.g., a content item, a scene graph, and/or a layer) may be generated at the clients 106. Using disclosed approaches, updates need not be rejected by the content management system 104, and a client 106 may send any number of updates to the content management system 104 without waiting for confirmations on prior updates.

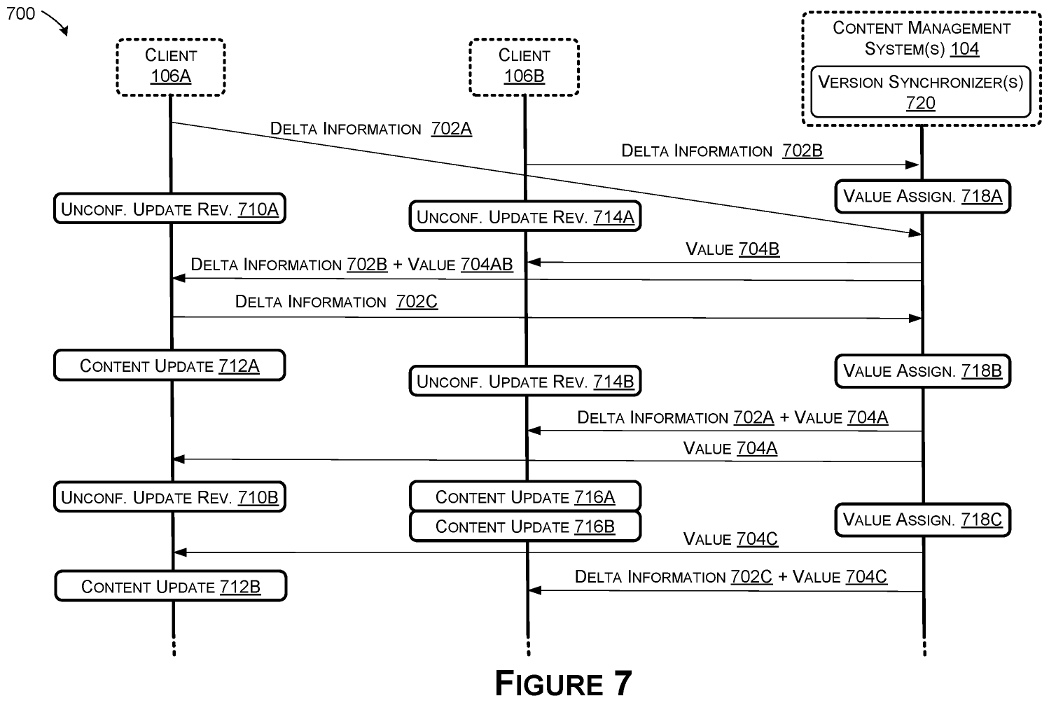

Referring now to FIG. 7, FIG. 7 is a data flow diagram showing an example of a process 700 for synchronizing versions of content of a 3D virtual environment, in accordance with some embodiments of the present disclosure. In various examples, a version synchronizer 720 may be used to assign the values to the updates. The version synchronizer(s) 720 may be implemented on one or more of the content management systems 104 and/or client devices 102 (e.g., in peer-to-peer embodiments or where a server is hosted on a client device).

The values assigned by the version synchronizer 720 may form a sequence of values that defines an order in which to apply the sets of delta information to the content (e.g., a scene description, such as a scene graph) to produce synchronized versions of the content. Further, each value may correspond to a version of the content. In embodiments, given a version of the content and its value in the sequence, any version of the content may be generated by any of the various content managers 410 by applying intervening sets of delta information in the order dictated by the corresponding values from the sequence.

In some embodiments, the values assigned by the version synchronizer 720 may comprise numbers (e.g., integer or floating point) and/or letters that the version synchronizer 720 increments for each assignment of a set of delta information to a value. For example, a first set of delta information may be assigned a value of 1, a second set of delta information may be assigned a value of 2, etc., in sequence. A content manager 410 of a client 106 that has the first and second sets of delta information may then determine the order to apply the updates based on the values (e.g., apply updates with earlier values in the sequence prior to updates with later values, and apply the updates without skipping any values in the sequence). In some examples, a formula or other algorithm may be used to derive a value in the sequence and/or an order in which to apply the sets of delta information using the values.

In some embodiments, the version synchronizer 720 may assign values to updates based at least on an order in which they are received. In some examples, the assignments may be in the order the updates are received. In further examples, when multiple updates have been received, but have not yet been assigned values and/or the assignments have not yet been provided to a client 106, the updates may be assigned values in a different order than the order in which the updates were received (e.g., due to processing delays for some updates, parallel processing, out-of-order processing, etc.).

In various examples, a client 106 may transmit (e.g., over the transport infrastructure 420) a set of delta information in an update request. The client 106 may mark or otherwise store (e.g., locally) an indication that the update is unconfirmed or pending. The client 106 need not wait for a response prior to sending additional sets of delta information in one or more subsequent update requests, and may similarly store an indication that those updates are unconfirmed or pending.

When the version synchronizer 720 receives an update request from a client 106, the version synchronizer 720 may assign a value in the sequence to the update. Where the client 106 has sent multiple update requests, they may not be processed by the version synchronizer 720 in the order in which the update requests were sent by the client 106. The value for an update may be provided (e.g., transmitted over the transport infrastructure 420) to the client 106 in response to the request. In embodiments where one or more other clients 106 are subscribed to the content or otherwise associated with the content or updates to the content, the set of delta information and/or the value may be provided (e.g., pushed) to each other client 106.

Depending on the implementation, the set of delta information and/or the value may be provided by another client 106 that received the information and/or may be provided directly to each client 106 by a server(s) of the content management system 104. In the example of FIG. 7, the content management system 104 may provide both the delta information and the value to each other client 106. In other examples, the client 106 that made the update request could provide the delta information to one or more other clients 106 (e.g., prior to or after receiving the confirmation or value from the version synchronizer 720).

As described herein, the content managers 410 of each client 106 may maintain a list, record, or other data that is used to track and/or determine unconfirmed sets of delta information (e.g., a set of delta information with no associated value). When a value is received by a content manager 410 for a set of delta information, the content manager 410 may update the data to reflect the confirmation. Further, the content manager 410 may or may not apply the corresponding update to a local copy of the content for various potential reasons. For example, the content manager 410 may not yet have a value and/or corresponding update that is to be applied in the order prior to the confirmed update according to the sequence of values. Once the intervening information is received, the content manager 410 may apply each update in order. Additionally, the content manager 410 may delay applying updates even where each intervening update has been received and confirmed. For example, the content manager 410 may apply updates periodically, in response to a user command to apply the updates, using batch processing, and/or based on other factors that may introduce delays (which may vary across the clients 106). In embodiments where a client 106 is not configured to or capable of contributing updates to the content, the content manager 410 of the client 106 may not include capabilities for tracking unconfirmed updates, but may still include functionality to ensure the updates are applied in the order.

Describing the process 700 as an example, at the outset of the process 700 the client 106A and the client 106B may each have a version of content and a value in the sequence of values associated with that version of content (e.g., the value of the version of content). In other examples, the client 106A and the client 106B may have different versions of the content. Also by way of example, the clients 106A and 106B do not have any unconfirmed or unapplied sets of delta information for the content. However, in other examples, one or both of the clients 106 may have one or more unconfirmed or unapplied sets of delta information either received by the client 106 or transmitted to the content management system 104 from the client 106.

As shown in FIG. 7, the content manager 410A of the client 106A may generate and send delta information 702A to the content management system 104. The content manager 410A of the client 106A may, based at least on sending the delta information 702A, perform an unconfirmed update revision 710A. The unconfirmed update revision 710A may be to a list, record, or other data that the content manager 410A may use to track and/or determine one or more sets of delta information that are local to the content manager 410A and/or client device, but have not yet been confirmed by the content management system 104. For example, the unconfirmed update revision 710A may record that the delta information 702A has not yet been confirmed by the content management system 104. While the unconfirmed update revision 710A is shown after sending of the delta information 702A, in other examples, the unconfirmed update revision 710A could occur prior to the sending of the delta information 702A.

Also shown in FIG. 7, the content manager 410B of the client 106B may send delta information 702B to the content management system 104 after the delta information 702A is sent from the client 106A. The content manager 410B of the client 106B may, based at least on sending the delta information 702B, perform an unconfirmed update revision 714A which may be similar to the unconfirmed update revision 710A. For example, the unconfirmed update revision 714A may be to a list, record, or other data that the content manager 410B may use to track and/or determine one or more sets of delta information that are local to the content manager 410B and/or client device, but have not yet been confirmed by the content management system 104.

In this example, despite having been sent after the delta information 702A, the delta information 702B may be received by the content management system 104 prior to the delta information 702A. The version synchronizer 720 may be configured to assign values to sets of delta information based at least on an order in which the sets of delta information are received by the content management system 104 (e.g., in the order in which the sets are received). For example, in response to receiving the delta information 702B, the version synchronizer 720 may perform a value assignment 718A of a value 704B to the delta information 702B. In at least one embodiment, this may include incrementing a prior value of the sequence to the value 704B in the sequence (or the value may be been previously incremented, for example, when assigning the prior value to a set of delta information). Also in response to receiving the delta information 702B, the content management system 104 may transmit the value 704B to the client 106B (the client that provided the update) in association with the delta information 702B.

In at least one embodiment, the content manager 410B of the client 106B may, based on receiving the value 704B, perform an unconfirmed update revision 714B to record that the delta information 702B has been confirmed. Also based at least on receiving the value 704B, the content manager 410B of the client 106B may perform a content update 716A to a version of content on the client 106B using the delta information 702B. The content update 716A may be performed based at least on the value 704B following (e.g., immediately following) a value that corresponds to the version of the content in the sequence. Further, in some examples, the unconfirmed update revision 714B may occur after and/or as part of the content update 716A and/or a content update 716B (e.g., using a batch or periodic update).

In at least one embodiment, also in response to receiving the delta information 702B, the content management system 104 may transmit the value 704B and the delta information 702B to one or more other clients 106. For example, the content management system 104 may transmit the value 704B and the delta information 702B to each client 106 that is subscribed to the content. Thus, as shown, the client 106A may receive the delta information 702B and the value 704B. The content manager 410A of the client 106A may perform a content update 712A of a version of content on the client 106A using the delta information 702B.

Also shown in the process 700, the content manager 410A of the client 106A may transmit delta information 702C to the content management system 104 prior to receiving a value and/or confirmation for the delta information 702A. The version synchronizer 720 may perform a value assignment 718B of a value 704A to the delta information 702A. In at least one embodiment, this may include incrementing the value 704B, which may be the prior value in the sequence. Also based on receiving the delta information 702A, the content management system 104 may transmit the value 704A to the client 106A in association with the delta information 702A. Further the content management system 104 may transmit the value 704A and the delta information 702A to any other clients 106 (e.g., the client 106B in the example shown), such as those subscribed to the content.

The content manager 410A of the client 106A may, based at least on receiving the value 704A, perform an unconfirmed update revision 710B to indicate the delta information 702A has been confirmed, and/or to record the value 704A. The content manager 410A of the client 106A may also perform a content update 712B using the delta information 702A. Further, the content manager 410B of the client 106B may, based at least on receiving the value 704A and the delta information 702A, perform the content update 716A using the delta information 702B and a content update 716B using the delta information 702A. The version synchronizer 720 may perform a value assignment 718C of a value 704C to the delta information 702C, provide the value 704C to the client 106A, and provide the value 704C and the delta information 702C to the client 106B.

The process 700 may continue as additional sets of delta information are transmitted to the content management system 104. While the process 700 may relate to a single content item, the content management system(s) 104 may perform similar processes with any number of content items (e.g., concurrently with the content item of FIG. 7). These processes may include one or more of the same and/or different clients 106 as the process 700 and have a separate sequence of values used for ordering the application of delta information. For example, different clients 106 may be subscribed to different content items, which may all be part of a common virtual environment and/or scene description. Further, some of the clients 106 may be operating on (e.g., collaborating on and/or viewing) different virtual environments than others or may not be subscribed to all of the content of a virtual environment.

Disclosed approaches provide significant flexibility in the manner, order, and timing in which the clients 106 transmit, generate, and apply updates to content, while providing for synchronization between versions of the content. FIG. 7 shows some examples, but is not intended to be limiting to the examples shown.

As described herein, a set of delta information may represent one or more property-values pairs of an updated version of an asset procedurally, such as using one or more commands that may be performed on a version of the asset(s), such as a create command, a delete command, a modify command, a rename command, and/or a re-parent command with respect to one or more property-values pairs of the scene description (e.g., one or more structural elements and/or non-structural elements) that may be executed in sequence to construct the updated version of the asset(s). The difference data may also represent and/or indicate a sequence in which the commands are to be executed (e.g., via timestamps or listing them in sequence). In various examples, one or more of the commands may be or may include at least some of the same commands executed by the client 106 that provided the set of delta information and/or a user of a client device to locally modify the content. Also, the sequence correspond to and/or be the same sequence in which commands were executed by the client 106 and/or entered by a user of a client device. In other examples, these commands may be modified, or optimized, to capture an equivalent result.

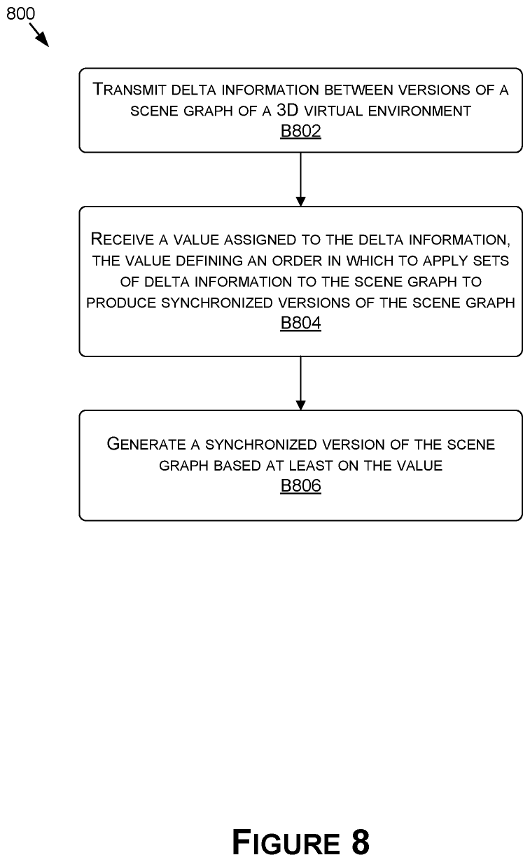

Now referring to FIGS. 8-10, each block of methods 800, 900, and 1000, and other methods described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, the methods are described, by way of example, with respect to the operating environment 100 and FIG. 7. However, these methods may additionally or alternatively be executed by any one system, or any combination of systems, including, but not limited to, those described herein.

FIG. 8 is a flow diagram showing a method 800 a client may use for updating a synchronized version of content, in accordance with some embodiments of the present disclosure. The method 800, at block B802, includes transmitting delta information between versions of a scene graph of a 3D virtual environment. For example, the client 106A may transmit the delta information 702A between versions of a scene graph of a three-dimensional (3D) virtual environment to the content management system 104.

The method 800, at block B804 includes receiving a value assigned to the delta information, the value defining an order in which to apply sets of delta information to the scene graph to produce synchronized versions of the scene graph. For example, the client 106A may receive data indicating the value 704A assigned to the delta information 702A. As described herein, the value 704A may be of a sequence of values that defines an order in which to apply sets of delta information to the scene graph to produce synchronized versions of the scene graph.

The method 800, at block B806 includes generating a synchronized version of the scene graphs based at least on the value. For example, the client 106A may perform the content update 712B to generate a synchronized version of the synchronized versions of the scene graph based at least on applying the delta information 702A to the scene graph in the order using the value 704A.

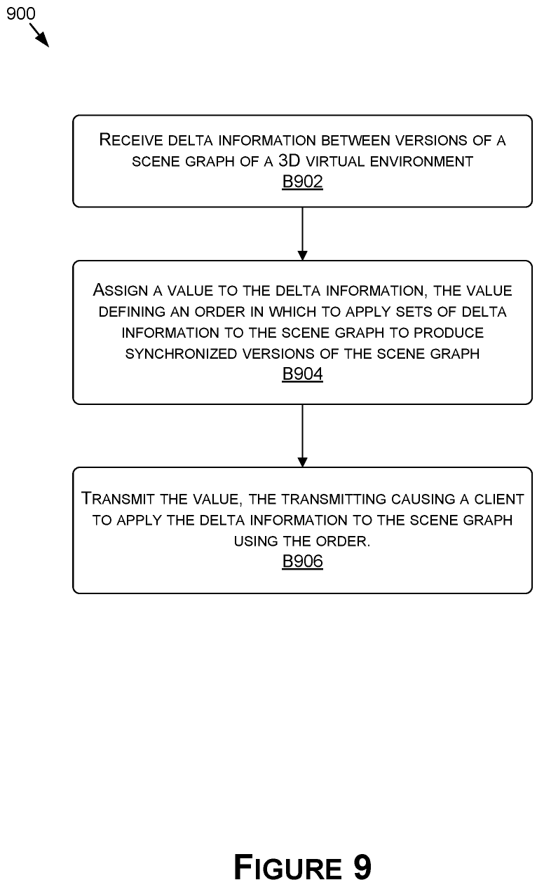

Referring now to FIG. 9, FIG. 9 is a flow diagram showing a method 900 a server may use for updating a synchronized version of content, in accordance with some embodiments of the present disclosure. The method 900, at block B902, includes receiving delta information between versions of a scene graph of a 3D virtual environment. For example, the content management system 104 may receive, from the client 106A, the delta information 702A between versions of a scene graph of a 3D virtual environment.

The method 900, at block B904 includes assigning a value to the delta information, the value defining an order in which to apply sets of delta information to the scene graph to produce synchronized versions of the scene graph. For example, the version synchronizer 720 may assign the value 704A to the delta information 702A. As described herein, the value 704A may be of a sequence of values that defines an order in which to apply sets of delta information to the scene graph to produce synchronized versions of the scene graph.

The method 900, at block B906 includes transmitting the value, the transmitting causing the client to apply the delta information to the scene graph using the order. For example, the content management system 104 may transmit data indicating the value 704A to the client 106A. The transmitting may cause the client 106A to apply the delta information 702A to the scene graph using the order in the content update 712B.

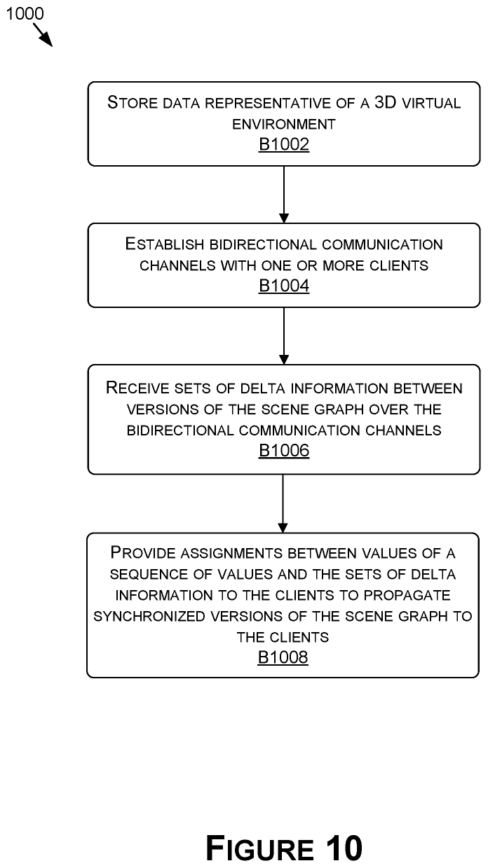

Referring now to FIG. 10, FIG. 10 is a flow diagram showing a method 1000 for managing synchronization of versions of content, in accordance with some embodiments of the present disclosure. The method 1000, at block B1002, includes storing data representative of a 3D virtual environment. For example, the content management system 104 may store data representative of a scene graph of a 3D virtual environment in a data store.

The method 1000, at block B1004 includes establishing bidirectional communication channels with one or more clients. For example, the content management system 104 may establish bidirectional communication channels with the clients 106A and 106B. The bidirectional communication channels may be used to receive sets of delta information between versions of a scene graph from the clients 106A and 106B. The bidirectional communication channels may also be to provide assignments between values of a sequence of values and the sets of delta information to the clients 106A and 106B to propagate synchronized versions of the scene graph to the clients 106A and 106B.

The method 1000, at block B1006 includes receiving sets of delta information between versions of the scene graph over the bidirectional communication channels. For example, the content management system 104 may receive the sets of delta information between versions of the scene graph from the clients 106A and 106B.

The method 1000, at block B1008 includes providing assignments between values of a sequence of values and the sets of delta information to the clients to propagate synchronized versions of the scene graph to the clients. For example, the content management system 104 may provide assignments made by the version synchronizer 720 between values of the sequence of values and the sets of delta information to the clients 106A and 106B to propagate the synchronized versions of the scene graph to the clients 106A and 106B.

### Examples of Delta Formats

In at least one embodiment, a set of delta information may include a section defining one or more changes to one or more structural elements of scene description and a section defining one or more changes to one or more non-structural elements of the scene description. As described herein, structural elements may correspond to graph nodes of a scene graph, as well as the interconnections shown between the nodes. Also described herein, non-structural elements may refer to properties and/or values (e.g., field-value pairs) assigned to nodes and/or structural elements. A non-structural element generally may not impact the structure of the scene graph, whereas a structural element may define structure of the scene graph. For example, in FIGS. 2A and 2B, the assets may be structural elements and the property-values pairs may be non-structural elements.

In various embodiments, one or more changes to the structural elements of a set of delta information may be defined or specified procedurally. For example, one or more create commands, delete commands, modify commands, rename commands, and/or re-parent commands may be sequentially defined with respect to one or more structural elements. As updates to the structural elements may be defined procedurally in a set of delta information, a content manager 410 and/or the content management system 104 may apply the updates in the order defined in the set of delta information, thereby providing a consistent structural configuration of the scene description across different components of the operating environment 100. For example, given structural elements A and B, A is renamed to C and B to A, then C to B, the result is that the structural elements get renamed to each other, and if they are not applied in that particular order by all of the components, there would be different and inconsistent results.

In some embodiments, conflicts may arise as clients 106 may modify the same synchronized version of a scene description concurrently, then generate and send corresponding sets of delta information. For example, one client 106 may generate a first set of delta information that deletes a structural element and another client 106 may generate a second set of delta information that assigns a non-structural field-value pair to the structural element. If values assigned to the first and second sets of delta information by the version synchronizer 720 define the order so the second set is to be applied after the first set, the command may operate on a non-existent element. To account for this, each component of the operating environment 100 that applies the sets of delta information may be configured to apply a common set of conflict resolution rules when applying a set of delta information. In the present example, each component may ignore or discard commands for non-existent elements to resolve conflicts.

In at least one embodiment, one or more changes to the non-structural elements of the set of delta information may be defined or specified declaratively. In at least one embodiment, each non-structural element that is changed in a set of delta information may be specified a single time with its final value. For example, if a client 106 changes a value of a field from a current version of scene description multiple times when editing a local copy of the scene description, the content manager 410 may include only a latest, last, or most recent value of the field description in a corresponding set of delta information. Specifying non-structural elements declaratively may reduce the size of the sets of delta information while still resulting in consistent results between components of the operating environment 100. However, as described herein, for structural elements, the client 106 may include all changes made to the scene description, procedurally, in the order in which they occurred. While in some cases, the content manager 410 may condense or optimize the procedural changes, sending all changes may allow for faster transfer times by reducing processing.

In at least one embodiment, each node of a scene description (e.g., scene graph) may have a unique identifier (ID). In some embodiments, the unique ID of a node may be assigned to the node upon creation of the node (e.g., in a create command). The unique ID may be used for the node its entire life, whether it be renamed, removed, or re-parented. Structural changes to a node and/or changes and/or assignments of property-value pairs (e.g., fields and/or field values) to the node may be specified using the node's unique ID. In some embodiments, the unique ID may be generated and/or assigned to a node by a client 106 that creates the node. For example, the unique ID (which may more generally be referred to as a node ID) for a node may be a randomly generated 64 or 128-bit number. Thus, to change a field value of a field of a node, a set of delta information may include the node ID, a field ID, and the field value.

Examples of Data Storage of Content that Includes Hierarchical Elements

The data store 114 may store scene description using a variety of potential formats and approaches. In some examples, a key-value structure may be used to capture any change to the scene description. For example, where the scene description includes hierarchical elements, they may be collapsed down to a key-value pair, which could be stored in the data store 114. To illustrate the forgoing, table/bowl/color=blue may represent an assignment of a value to a color assigning to a bowl assigned to a table. However, such an approach may be complicated when changes that are permitted include renaming and/or reparenting of nodes of hierarchical elements in the scene description. For example, if one client 106 reparents the bowl to counter, the key would then be counter/bowl/color. However, another client 106 that is not yet aware of the change may update the old key. A similar issue may occur with renaming. Disclosed approaches allow for renaming and/or reparenting while avoiding these potential issues.

In accordance with some aspects of the disclosure, the data store 114 may store and reference structural elements (nodes) of the scene description using the node IDs, and non-structural elements may be assigned to the node IDs as field-value pairs. The field-value pairs may function as key-value pairs, except that rather than a single key-value pair in the data store, key-value pairs may be per-node ID or per node. For example, the nodes may be stored in a separate structure or table from key-value pairs in the data store 114. When a client 106 refers to a node, the client 106 may reference both the node ID and one or more relevant field-value pairs with the node ID allowing for identification of the proper node even if the node is reparented or renamed.

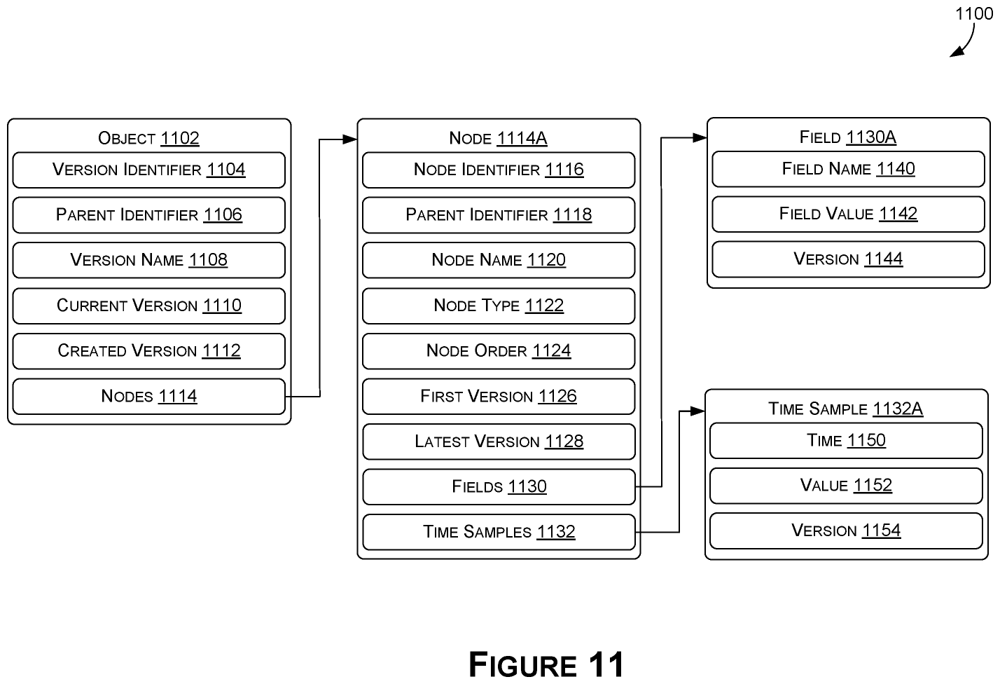

Referring now to FIG. 11, FIG. 11 is a diagram illustrating an example of a structure 1100 which may be used by a data store to capture an object 1102 representing hierarchical elements, in accordance with some embodiments of the present disclosure.

In various examples, each object (e.g., the object 1102) may represent a scene graph, a root of a hierarchical data structure, a file, a scene description, a layer and/or a 3D virtual environment or portion or version thereof. For example, each version of the object 1102 may itself be an object comprising the elements shown in FIG. 11. As shown, the object 1102 may include a version identifier 1104, a parent identifier 1106, a version name 1108, a current version 1110, a created version 1112, and one or more pointers to nodes 1114, an example of which include a node 1104A.

As described herein, each node (e.g., the node 1114A) may include a node identifier 1116, which may be used by a client 106 to reference the node. Other examples of data which may be included in a node are a parent identifier 1118, a node name 1120, a node type 1122, a node order 1124, a first version identifier 1126, a latest version identifier 1128, one or more pointers to one or more fields 1130, and one or more pointers to one or more time samples 1132.

The node name 1120 may comprise the name of the node. As the node name 1120 is separate from the node ID 1116, the node may be renamed while retaining the node ID 1116, as described herein. The parent identifier 1118 may comprise a node ID 1116 of a parent node of the node. The node type 1122 may specify a type of the node (e.g., whether the type of structural element, examples of which are described herein). The node order 1124 may specify an order of the node. In some examples, the node order 1124 may be used by a content manager 410 when traversing a scene graph and may specify or define an order in which the children are traversed. The node order 1124 may be used to account for situations where multiple clients 106 modify the structure (e.g., adding, removing, or reordering nodes) at the same time so as to ensure all clients 106 apply the nodes in the same order. The first version identifier 1126 may specify a first version of the object 1102 in which the node appeared in. The latest version identifier 1128 may specify a last version of the object 1102 in which the node was updated (any fields of the node). The latest version identifier 1128 may be used to skip processing of the node if the latest version of the node is already present (e.g., based on determining a present version identifier>=the latest version identifier 1128).

A field 1130A is an example of one of the fields 1130 which may be assigned to a node 1114A. Each field (e.g., the field 1130A) may include a field name 1140, a field value 1142, and a version identifier 1144.

A time sample 1132A is an example of one of the time samples 1132 which may be assigned to a node 1114A. Each time sample (e.g., the time sample 1132A) may include a time 1150, a value 1152, and a version identifier 1154.

The structure 1100 of FIG. 11 is an example of an implementation that supports versions of objects. As described herein, a version of an object may be persistently stored on the content management system 104, for example, in response to a request at the direction of a user or algorithm. The version identifier 1104 of the object 1102 may uniquely identify a version of the object 1102. In various examples, the data store manager 108 may assign version values to objects in the data store 114 that is sequential with respect to a particular object. The version values used to store and reference objects in the data store 114 may be different than or the same as values assigned to sets of delta information, and a new version of an object 1102 may be created for various reasons.

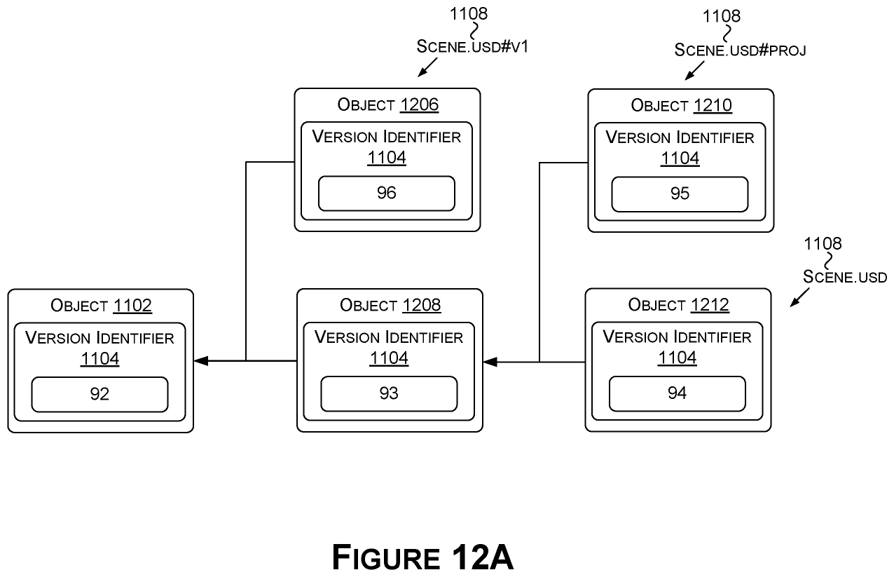

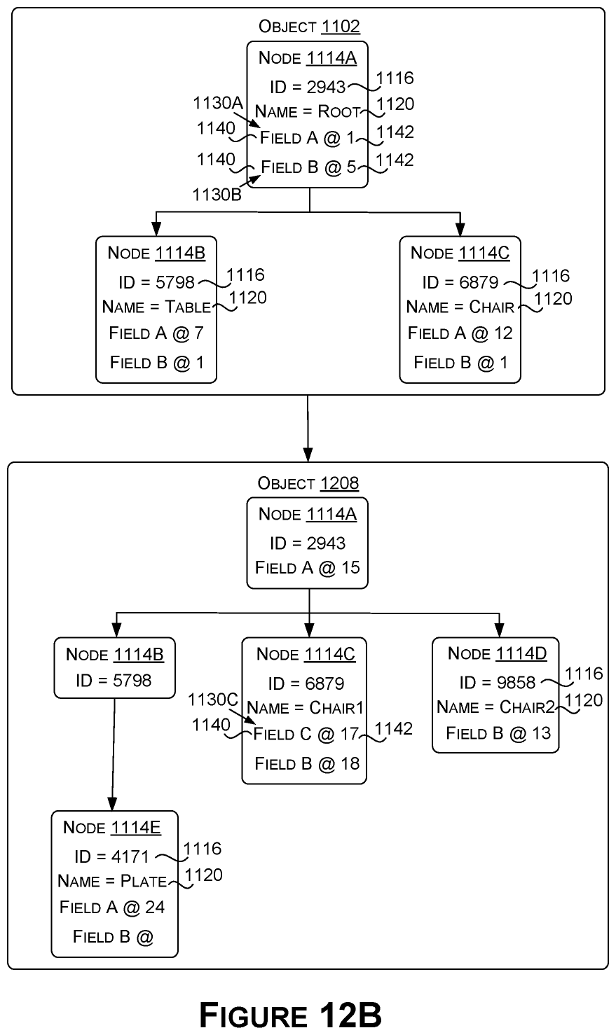

Referring now to FIG. 12A, FIG. 12A is a diagram illustrating an example of versions of the object 1102, in accordance with some embodiments of the present disclosure. For example, the object 1102 having the version identifier (ID) 1104 may be a parent of other objects shown in FIG. 12A. In various embodiments, versions of the object 1102 may branch where one object may have only one parent, but can have multiple children. For example, the object 1102 has children comprising an object 1206 and an object 1208. The object 1208 also includes children comprising an object 1210 and an object 1212.

The data store manager 108 may support fast branch switching, where if there are multiple children of the same parent, to transition a client 106 from one child to the other may be accomplished by generating and providing a set of delta information that may be applied by the client 106 to the child to produce the other child. For example, to switch from the object 1206 to the object 1208, 1210, or 1212, the data store manager 108 may generate a set of delta information between the versions of the object 1102. The set of delta information may be similar to or different than the delta information used to synchronize versions of scene description across clients. In some examples, changes to structural elements and non-structural elements may each be captured declaratively or structural changes may be captured procedurally. Using fast branch switching, the content management system 104 need not send any data from the parent version.

As described herein, the data store manager 108 may assign version values to objects in the data store 114 that is sequential with respect to a particular object. In embodiments, the data store manager 108 may assign version values, such that a child has a later value in the sequence (e.g., larger version number) with respect to each of the child's parents. However, traversing a particular branch there may be gaps, even where the sequence is incremented for each assignment of a version value. For example, in FIG. 12A, starting from a branch from the object 1102 where the version identifier 1104 is 92, along the branch the version identifier 1104 of the object 1208 may be 93 and the version identifier 1104 of the object 1212 may be 94. However, along another branch from the object 1102 where the version identifier 1104 is 92, there may be a gap in the sequence with the version identifier 1104 of the object 1206 being 96. This may indicate that the object 1206 was branched from the object 1102 after the other versions in FIG. 12A were created. Although a particular sequencing scheme is shown and described, other schemes could be employed, such as starting a new subsequence from each parent node and/or branch. For example, various approaches may be used including those sufficient for uniquely identifying versions, relationships between parents and children, and/or temporal relationships between versions, such as creation order.

In accordance with at least some embodiments, when the data store manager 108 creates a new version of the object 1102, for example, the object 1208, the parent identifier 1106 of the new object 1102 may be set to the previous version of the object. Rather than storing all of the data of the fields 1130 and time samples 1132, the new object may only store what has changed from the previous version, the remaining content may be captured using pointers included in the elements of the structure 1100.

The version name 1108 of an object may be used to reference the object. For example, a content manager 410 of a client 106 may reference an object using the version name 1108 of the object. In some examples, the data store manager 108 only allows for leaf objects to have names, and only leaf objects may be edited by a content manager 410. When a content manager 410 and/or the data store manager 108 copies an object, it may create a second entry of a name to object ID (which may refer to the version identifier 1104) mapping, where both mappings point to the same existing object. When the content manager 410 and/or the data store manager 108 updates one of the copies, a new object may be created to capture any changes, with the existing object being set as its parent.

Referring now to FIG. 12B, FIG. 12B is a diagram illustrating an example of data storage for versions of the object 1102, in accordance with some embodiments of the present disclosure. In various embodiments, the data store manager 108 may store nodes and/or values such that not present or missing nodes and/or fields from an object may indicate to the data store manager 108 that corresponding field values of fields or time samples from a parent (direct or indirect) are to be used for that object version. As an example, in the object 1102, the field value 1142 of “5” is stored for the field 1130B (“field B”) of the node 1114A. However, in the object 1208, no data is stored for the field 1130B (“field B”) for the node 1114A, indicating that the field 1130B should be included in the node 1114A for the object 1208. In particular, the field value 1142 and the field 1130B are to be retrieved from and defined by the nearest parent that includes data for the field 1130B (in this case the object 1102).

Similarly, for the node 1114B of the object 1208, the fields 1130A and 1130B with field values are to be included from the node 1114B of the object 1102, as the node 1114B of the object 1208 does not include data for the fields 1130A and 1130B. Node names may be treated similar to nodes and/or field names. Thus, as indicated in FIG. 12B, the node name 1120 of the node 1114A changes to “Chair1” for the object 1208. Further, the node name 1120 of the node 1114B is “table” for both the object 1102 and the object 1208. Nodes and/or field values that are added from a parent may also be stored in the child. For example, the node 1114C of the object 1208 adds a field 1130C. Nodes and/or field values that are deleted from a parent may be explicitly marked as deleted within the child or indicated by being present but blank. For example, the field 1130B in the node 1114E of the object 1208 is present, but has no value (is blank) to indicate to the data store manager 108 that the field 1130B has been deleted in the object 1208 and is not to be included in the node 1114E of the object 1208 (or children thereof unless redeclared).

Using disclosed approaches, the storage size of different versions of objects may be significantly reduced. For example, an object on disk may only have a few fields, but it may point to a parent object that has more fields to include in the object, which itself may point to another object with additional fields, all the way up the version chain. When a content manager 410 of a client 106 connects to a content management system 104 to receive a version of an object, if the client 106 does not have another version of the object (which may be indicated by the client 106), the data store manager 108 may coalesce the object versions to generate base data representative of the version of the object, and the base data may be transmitted to the client 106.

In some examples, the base data may be generated, at least partially, in advance of a client 106 connecting (e.g., to participate in collaborative editing and/or viewing a dynamic scene) to the content management system 104 and/or to the version of the object to reduce latency when or if a client 106 connects. Further, the base data may be updated periodically and/or in response to a client 106 connection request for transmittal to one or more clients 106. If the client 106 does have another version of the object (which may be indicated or specified by the client 106), the data store manager 108 may generate difference data representative of the differences between the version of the object at the client 106 and the desired version of the object. For example, the difference data may capture a minimum set of commands required to transform the client version into the desired version of the object. Thus, the content management system 104 need not send all of the deltas that were exchanged between the clients 106 in collaboratively creating the desired version of the object.

Version Caching

Disclosed approaches may also provide benefits to data caching objects across servers and/or edge devices, which may be remote from one another. For example, if a master, or core server of the content management system 104 is in Los Angeles and an edge, or cache server of the content management system 104 is in Moscow, it may be challenging to quickly transfer the data to the cache server for local hosting of an object. In accordance with some embodiments, versions of an object may be cached in a cache server in advance of a client 106 connection or request for a particular version of the object. If a client 106 requests a version that is not cached, the core server may send the difference data needed to get from a cached version to a requested version of the object.

In various embodiments, when a read request arrives from a client 106, the cache server may first check the cache to see if the request can be directly serviced by the cache. If so, the server may immediately respond with a redirect to Large File Transfer (LFT). LFT may refer to a method for the server to tell a client 106 to read the data through the cache server out of band by providing it with a URL (e.g., where the cache server may be an HTTP cache server). Small files (e.g., less than 4 KB or another LFT threshold value) may be returned directly in-band (e.g., through WebSockets or another form of direct transfer) rather than going through the LFT process.

For example, if there is no direct answer in the cache, the cache server may check to see what versions are in the cache, and estimate a size of the delta from those versions to the latest version, as well as the size from the version the client 106 has to the latest version. All of this information may be used to deliver the most optimal sequence of deltas (e.g., smallest total size) to the client 106 (e.g., in a single difference file). For example if the client 106 has version 0, the cache has versions 0->X, and the latest version is Y, the cache server may ask for an estimate to go from versions 0->Y and versions X->Y. The cache server also may know the size of versions 0->X from the cache. If the size of versions 0->Y is less than half of the size of versions (0->X+X->Y) then versions 0->Y may be written to the cache and returned. If the size of versions X->Y is less than the LFT threshold, then versions 0->X may be delivered as a redirect to LFT and versions X->Y over WebSocket or other direct transfer methods. If the size of versions X->Y is greater than the LFT threshold, then both versions 0->X and versions X->Y may be delivered as a redirect to LFT.

As a further example, assume the client 106 has version 15, the cache has versions 0->10, versions 10->20, and versions 20->30, and the latest is versions 40. In one approach, the client 106 may be served with a new delta of versions 15->40. In another approach the client 106 may be served with a new delta of versions 15->20, the existing delta of versions 20->30, and a new delta of versions 30->40. The cache server may estimate the size for both of these approaches. The first approach will always be smaller, but if it's not much smaller, then the second approach may be better because it results in a delta 30->40 which another client 106 may use later. In some embodiments, the cache server may choose the first approach based on determining the size ratio between the first approach and the second approach is less than a threshold value (e.g., 0.5). The new deltas may be sent either via LFT or over WebSocket or other direct transfer, depending on size.

The cache server may include a garbage collection process which periodically clears out old deltas from the cache that are no longer being used. This garbage collection may be triggered, for example, by a size threshold (e.g., when the cache grows beyond some size) and may clear out the least-recently-used deltas. To this effect, the cache may contain for each delta, the last time that delta was served from the cache. The garbage collection process may be configured to delete deltas based on not having been served for a threshold time. For example, the garbage collection process may be configured to never delete items that have been used more recently than 1 hour (or a configured LFT timeout value).

A read request from a client 106 for an object may return a difference between versions of the object. One of the versions may be the version the client 106 already has and the other may be the latest version on the core server. In an example scenario according to one or more embodiments, the client 106 may not have the object initially, which may be considered version 0. The content manager 410 of the client 106 may send a read request to the core server specifying version 0 as the latest version at the client 106. If the current version on the core server is version 1, the core server may generate difference data between versions 0 and 1, which may be written to a file with some unique File ID and a size of size1. The core server may generate some Content_Id with File_Id and range [0, size1), then return it back to the client 106. The client 106 may receive this Content_Id and initiate a download from the cache server. Assuming the cache server does not yet have a cached file with File_Id, the cache server may initiate a download from the core server of File_Id with range [0, size1). After the download is completed, there may be a cached file with File_Id and a size of size1. The client 106 may read the cached file and apply the difference data to update the object to version 1.

To continue the above example, now assume the core server has a newer version 2 and some other client 106 initiates a read with version 0. The core server already has difference data for versions 0->1 in a file with File_Id from the prior request. Thus, the core server may only generate difference data for versions 1->2, and append this difference data to the end of the file with File_Id, resulting in a file size of size2. A Content_Id2 may be generated with File_Id and range [0, size2), which is then returned back to the client 106. Assuming the [0, size1) range is already in the cache for File_Id, only [size1, size2) may need to be downloaded from the core server.

If the current version at the core server is version 3, and first client 106 with version 1 initiates another read request, since the core server already has difference data for versions 0->2 in a file with File_Id, it may only generate difference data for versions 2->3, and append this difference data to the end of file with File_Id having a resultant file size of size3. A new Content_Id3 may be generated with File_Id and range [size1, size3) and may be returned back to the client 106. Since the [0, size2) range would already be in the cache for File_Id, only [size2, size3) may need to be downloaded from the core server.

If the server/cache file has only difference data for versions 0->10, 10->20, and 20->30, and a client 106 initiates a read indicating it has a version 15, at least the difference data of versions 20->30 may be reused, and versions 15->20 may be generated as a new file, or versions 15->30 may be generated as a new file. This may occur, for example, when a connection was lost or the client 106 switches from offline to online. While the forgoing describes one large file and returning ranges, in other examples, separate files may be used for storage and these files may be returned rather than ranges (using corresponding File Ids).

A file for an object may always be growing, so at some point it may be desirable to reset the file and start over while discarding all content IDs referencing this file. It may not always be possible to reset and reuse the same file, such as where there is an active download of the file. Thus, a new file may be started, and the old file may be deleted once all downloads for the old file are completed.

If there are multiply differences in with the same big value changes in one file, reading and applying this same big value may be optimized by searching for only the latest change over all the differences. For example assume diff versions 0->10 has value1 with a big change, diff versions 10->20 has value1 and value2 with a big change, and diff versions 20->30 has value2 with a big change. When processing versions 0->30 on a client 106, only value1 from versions 10->20 and value2 from versions 20->30 may be taken, ignoring value1 from versions 0->10 and value2 from versions 10->20.

Example Database Format

In various embodiments, the objects and version of object may be stored using a plurality of tables. An OBJECT_ID table may use object ID as a key, and values may be the ID of the latest object created. A PATH_TO_OBJECT_ID table may capture mappings between object names (e.g., used by content managers 410 to reference objects) and object IDs.

An OBJECT_REFCOUNT table may use object ID as a key. The value may represent how many objects or paths reference the object. In some embodiments, if the data store manager 108 determines there is a reference to the object from the table, the data store manager 108 will not delete the object. For example, in an example scenario where there is a tree of objects all referencing each other with object A branching to object B and to objects C and D, object A should not be deleted because it is referenced by other objects. However, once the children objects are deleted and no referencing object remain, the parent will also be deleted.

An OBJECT_HEADER table may use object ID as a key. The value may represent a packed structure with version information and parent objects for the object. This may be used for scenarios where if an object is deleted and an object is recreated with the same name, a client 106 can determine it is a different object.

An OBJECT_NODE table may use object ID\node ID as a key. The value may represent a structure with the NODE IDs of children in the child list.

An OBJECT_FIELD_VERSION table may use as a key object ID/Node ID/Field Name. The value may be of a structure with the node information, such as described in FIG. 11.

An OBJECT_FIELD_DATA table may use as a key object ID/Node ID/Field Name. The value may represent the field value for the field.

An OBJECT_TIME_SAMPLE_VERSION table may use as a key object ID/Node ID/time. The value may represent the versions of every time sample in the node and also the name of every time sample in that node.

An OBJECT_TIME_SAMPLE_DATA table may use as a key object ID/Node ID/time. The value may represent the field value for the field. The value may represent the time temple value of the time sample.

### ADDITIONAL EXAMPLE

In at least one embodiment, a system includes a processing unit and memory coupled to the processing unit and having stored therein a data store to store data representative of objects of a three dimensional (3D) environment, where an object of the objects comprises a set of properties and values defined across content items of scene description of the 3D environment. The system also includes a communications manager coupled to the memory and operable for establishing bidirectional communication channels with clients for access to one or more of the content items of the 3D environment. Delta information representative of one or more changes to the set of properties and values of the object of a content item of the content items contributed to by a first client of the clients over a first of the bidirectional communication channels is saved to the data store and provided over a second of the bidirectional communication channels to at least a second client of the clients based on a subscription by the second client to the content item. The content item may be a layer of layers of the scene description and the set of properties and values of the object may be resolved by a ranking of the layers.

Example Computing Device

FIG. 13 is a block diagram of an example computing device(s) 1300 suitable for use in implementing some embodiments of the present disclosure. Computing device 1300 may include an interconnect system 1302 that directly or indirectly couples the following devices: memory 1304, one or more central processing units (CPUs) 1306, one or more graphics processing units (GPUs) 1308, a communication interface 1310, input/output (I/O) ports 1312, input/output components 1314, a power supply 1316, one or more presentation components 1318 (e.g., display(s)), and one or more logic units 1320.

In at least one embodiment, the computing device(s) 1300 may comprise one or more virtual machines, and/or any of the components thereof may comprise virtual components (e.g., virtual hardware components). For example, one or more of the GPUs 1308 may comprise one or more vGPUs, one or more of the CPUs 1306 may comprise one or more vCPUs, and/or one or more of the logic units 1320 may comprise one or more virtual logic units.

Although the various blocks of FIG. 13 are shown as connected via the interconnect system 1302 with lines, this is not intended to be limiting and is for clarity only. For example, in some embodiments, a presentation component 1318, such as a display device, may be considered an I/O component 1314 (e.g., if the display is a touch screen). As another example, the CPUs 1306 and/or GPUs 1308 may include memory (e.g., the memory 1304 may be representative of a storage device in addition to the memory of the GPUs 1308, the CPUs 1306, and/or other components). In other words, the computing device of FIG. 13 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 13.

The interconnect system 1302 may represent one or more links or busses, such as an address bus, a data bus, a control bus, or a combination thereof. The interconnect system 1302 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1306 may be directly connected to the memory 1304. Further, the CPU 1306 may be directly connected to the GPU 1308. Where there is direct, or point-to-point connection between components, the interconnect system 1302 may include a PCIe link to carry out the connection. In these examples, a PCI bus need not be included in the computing device 1300.

The memory 1304 may include any of a variety of computer-readable media. The computer-readable media may be any available media that may be accessed by the computing device 1300. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1304 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1300. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1306 may be configured to execute at least some of the computer-readable instructions to control one or more components of the computing device 1300 to perform one or more of the methods and/or processes described herein. The CPU(s) 1306 may each include one or more cores (e.g., one, two, four, eight, twenty-eight, seventy-two, etc.) that are capable of handling a multitude of software threads simultaneously. The CPU(s) 1306 may include any type of processor, and may include different types of processors depending on the type of computing device 1300 implemented (e.g., processors with fewer cores for mobile devices and processors with more cores for servers). For example, depending on the type of computing device 1300, the processor may be an Advanced RISC Machines (ARM) processor implemented using Reduced Instruction Set Computing (RISC) or an x86 processor implemented using Complex Instruction Set Computing (CISC). The computing device 1300 may include one or more CPUs 1306 in addition to one or more microprocessors or supplementary co-processors, such as math co-processors.

In addition to or alternatively from the CPU(s) 1306, the GPU(s) 1308 may be configured to execute at least some of the computer-readable instructions to control one or more components of the computing device 1300 to perform one or more of the methods and/or processes described herein. One or more of the GPU(s) 1308 may be an integrated GPU (e.g., integrated with one or more of the CPU(s) 1306 and/or one or more of the GPU(s) 1308 may be a discrete GPU)s. In embodiments, one or more of the GPU(s) 1308 may be a coprocessor of one or more of the CPU(s) 1306. The GPU(s) 1308 may be used by the computing device 1300 to render graphics (e.g., 3D graphics) or perform general purpose computations. For example, the GPU(s) 1308 may be used for General-Purpose computing on GPUs (GPGPU). The GPU(s) 1308 may include hundreds or thousands of cores that are capable of handling hundreds or thousands of software threads simultaneously. The GPU(s) 1308 may generate pixel data for output images in response to rendering commands (e.g., rendering commands from the CPU(s) 1306 received via a host interface). The GPU(s) 1308 may include graphics memory, such as display memory, for storing pixel data or any other suitable data, such as GPGPU data. The display memory may be included as part of the memory 1304. The GPU(s) 1308 may include two or more GPUs operating in parallel (e.g., via a link). The link may directly connect the GPUs (e.g., using NVLINK) or may connect the GPUs through a switch (e.g., using NVSwitch). When combined together, each GPU 1308 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1306 and/or the GPU(s) 1308, the logic unit(s) 1320 may be configured to execute at least some of the computer-readable instructions to control one or more components of the computing device 1300 to perform one or more of the methods and/or processes described herein. In embodiments, the CPU(s) 1306, the GPU(s) 1308, and/or the logic unit(s) 1320 may discretely or jointly perform any combination of the methods, processes and/or portions thereof. One or more of the logic units 1320 may be part of and/or integrated in one or more of the CPU(s) 1306 and/or the GPU(s) 1308 and/or one or more of the logic units 1320 may be discrete components or otherwise external to the CPU(s) 1306 and/or the GPU(s) 1308. In embodiments, one or more of the logic units 1320 may be a coprocessor of one or more of the CPU(s) 1306 and/or one or more of the GPU(s) 1308.

Examples of the logic unit(s) 1320 include one or more processing cores and/or components thereof, such as Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1310 may include one or more receivers, transmitters, and/or transceivers that enable the computing device 1300 to communicate with other computing devices via an electronic communication network, included wired and/or wireless communications. The communication interface 1310 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The I/O ports 1312 may enable the computing device 1300 to be logically coupled to other devices including the I/O components 1314, the presentation component(s) 1318, and/or other components, some of which may be built in to (e.g., integrated in) the computing device 1300. Illustrative I/O components 1314 include a microphone, mouse, keyboard, joystick, game pad, game controller, satellite dish, scanner, printer, wireless device, etc. The I/O components 1314 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1300. The computing device 1300 may include depth cameras, such as stereoscopic camera systems, infrared camera systems, RGB camera systems, touchscreen technology, and combinations of these, for gesture detection and recognition. Additionally, the computing device 1300 may include accelerometers or gyroscopes (e.g., as part of an inertia measurement unit (IMU)) that enable detection of motion. In some examples, the output of the accelerometers or gyroscopes may be used by the computing device 1300 to render immersive augmented reality or virtual reality.

The power supply 1316 may include a hard-wired power supply, a battery power supply, or a combination thereof. The power supply 1316 may provide power to the computing device 1300 to enable the components of the computing device 1300 to operate.

The presentation component(s) 1318 may include a display (e.g., a monitor, a touch screen, a television screen, a heads-up-display (HUD), other display types, or a combination thereof), speakers, and/or other presentation components. The presentation component(s) 1318 may receive data from other components (e.g., the GPU(s) 1308, the CPU(s) 1306, etc.), and output the data (e.g., as an image, video, sound, etc.).

Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1300 of FIG. 13—e.g., each device may include similar components, features, and/or functionality of the computing device(s) 1300.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1300 described herein with respect to FIG. 13. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

Example Data Center

FIG. 14 illustrates an example data center 1400, in which at least one embodiment may be used. In at least one embodiment, data center 1400 includes a data center infrastructure layer 1410, a framework layer 1420, a software layer 1430 and an application layer 1440.

In at least one embodiment, as shown in FIG. 14, data center infrastructure layer 1410 may include a resource orchestrator 1412, grouped computing resources 1414, and node computing resources (“node C.R.s”) 1416(1)-1416(N), where “N” represents any whole, positive integer. In at least one embodiment, node C.R.s 1416(1)-1416(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 1416(1)-1416(N) may be a server having one or more of above-mentioned computing resources.

In at least one embodiment, grouped computing resources 1414 may include separate groupings of node C.R.s housed within one or more racks (not shown), or many racks housed in data centers at various geographical locations (also not shown). Separate groupings of node C.R.s within grouped computing resources 1414 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 1422 may configure or otherwise control one or more node C.R.s 1416(1)-1416(N) and/or grouped computing resources 1414. In at least one embodiment, resource orchestrator 1422 may include a software design infrastructure (“SDI”) management entity for data center 1400. In at least one embodiment, resource orchestrator may include hardware, software or some combination thereof.

In at least one embodiment, as shown in FIG. 14, framework layer 1420 includes a job scheduler 1432, a configuration manager 1434, a resource manager 1436 and a distributed file system 1438. In at least one embodiment, framework layer 1420 may include a framework to support software 1444 of software layer 1430 and/or one or more application(s) 1442 of application layer 1440. In at least one embodiment, software 1444 or application(s) 1442 may respectively include web-based service software or applications, such as those provided by Amazon Web Services, Google Cloud and Microsoft Azure. In at least one embodiment, framework layer 1420 may be, but is not limited to, a type of free and open-source software web application framework such as Apache Spark™ (hereinafter “Spark”) that may utilize distributed file system 1438 for large-scale data processing (e.g., “big data”). In at least one embodiment, job scheduler 1432 may include a Spark driver to facilitate scheduling of workloads supported by various layers of data center 1400. In at least one embodiment, configuration manager 1434 may be capable of configuring different layers such as software layer 1430 and framework layer 1420 including Spark and distributed file system 1438 for supporting large-scale data processing. In at least one embodiment, resource manager 1436 may be capable of managing clustered or grouped computing resources mapped to or allocated for support of distributed file system 1438 and job scheduler 1432. In at least one embodiment, clustered or grouped computing resources may include grouped computing resource 1414 at data center infrastructure layer 1410. In at least one embodiment, resource manager 1436 may coordinate with resource orchestrator 1412 to manage these mapped or allocated computing resources.

In at least one embodiment, software 1444 included in software layer 1430 may include software used by at least portions of node C.R.s 1416(1)-1416(N), grouped computing resources 1414, and/or distributed file system 1438 of framework layer 1420. One or more types of software may include, but are not limited to, Internet web page search software, e-mail virus scan software, database software, and streaming video content software.

In at least one embodiment, application(s) 1442 included in application layer 1440 may include one or more types of applications used by at least portions of node C.R.s 1416(1)-1416(N), grouped computing resources 1414, and/or distributed file system 1438 of framework layer 1420. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 1434, resource manager 1436, and resource orchestrator 1412 may implement any number and type of self-modifying actions based on any amount and type of data acquired in any technically feasible fashion. In at least one embodiment, self-modifying actions may relieve a data center operator of data center 1400 from making possibly bad configuration decisions and possibly avoiding underutilized and/or poor performing portions of a data center.

In at least one embodiment, data center 1400 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 1400. In at least one embodiment, trained machine learning models corresponding to one or more neural networks may be used to infer or predict information using resources described above with respect to data center 1400 by using weight parameters calculated through one or more training techniques described herein.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

1. A method comprising:
transmitting, by a client of a content management system, delta information between versions of a scene graph of a three-dimensional (3D) virtual environment;
receiving, by the client, data indicating a value assigned to the delta information, the value being of a sequence of values that defines an order to apply sets of delta information to the scene graph to synchronize the scene graph; and
generating, by the client, a synchronized scene graph based at least on applying the delta information to the scene graph in the order using the value.

2. The method of claim 1, wherein the generating of the synchronized scene graph includes executing, on a prior synchronized version of the scene graph, a procedural update to the scene graph that is specified by the delta information, the procedural update comprising an ordered list of commands performed on one or more nodes of the scene graph.

3. The method of claim 1, wherein the generating of the synchronized scene graph includes executing, on a prior synchronized version of the scene graph, a declarative update to the scene graph that is specified by the delta information, the declarative update defining at least one assignment of a field value to a node of the scene graph.

4. The method of claim 1, wherein the delta information specifies a procedural update to one or more structural elements of the scene graph and a declarative update to one or more non-structural elements of the scene graph.

5. The method of claim 1, further comprising:
after the transmitting of the delta information, receiving, by the client, different delta information and a different value of the sequence of values that is assigned to the different delta information; and
generating, by the client, an earlier version of the scene graph than the synchronized scene graph based at least on the different value corresponding to an earlier position in the order than the value.

6. The method of claim 1, wherein the generating of the synchronized scene graph is from a prior synchronized version of the scene graph and the generating is performed based at least on determining the value assigned to the delta information follows a prior value of the sequence of values that is assigned to the prior synchronized version.

7. The method of claim 1, wherein the generating of the synchronized scene graph is from a prior synchronized version of the scene graph, the delta information specifies at least one command that has a conflict with the prior synchronized version, and the applying the delta information to the scene graph uses a conflict resolution rule to resolve the conflict.

8. The method of claim 1, wherein each set of the sets of delta information defines a respective synchronized version of the scene graph.

9. The method of claim 1, wherein the delta information specifies a command to perform on a structural element of the scene graph using a node identifier of a node that represents the structural element in the scene graph.

10. The method of claim 1, wherein the delta information defines an assignment of a non-structural element to a structural element of the scene graph using a node identifier of a node that represents the structural element in the scene graph.

11. A method comprising:
receiving, from a first client of a content management system, delta information between versions of a scene graph of a three-dimensional (3D) virtual environment;
assigning a value to the delta information, the value being of a sequence of values that defines an order to apply sets of delta information to the scene graph to produce one or more synchronized versions of the scene graph; and
transmitting data indicating the value to the first client, the transmitting causing the first client to apply the delta information to the scene graph using the order.

12. The method of claim 11, further comprising transmitting, to a second client of the content management system, the value of the sequence of values and the delta information between versions of the scene graph, the transmitting causing the second client to apply the delta information to the scene graph using the order.

13. The method of claim 11, further comprising:
receiving, from a second client, different delta information between versions of the scene graph;
assigning a different value of the sequence of values to the different delta information; and
transmitting data indicating the different value to the first client, the transmitting causing the first client to apply the different delta information to the scene graph using the order.

14. The method of claim 11, further comprising defining the order to apply the sets of delta information based on an order the sets of delta information are received from clients of the content management system.

15. A system comprising:
at least one processing unit; and
memory coupled to the at least one processing unit and having stored therein a data store to store data representative of a scene graph of a three dimensional (3D) virtual environment; and
a communications manager coupled to the memory and operable for establishing bidirectional communication channels with clients, the bidirectional communication channels to receive sets of delta information between versions of the scene graph from the clients, and to provide assignments between values of a sequence of values and the sets of delta information to the clients to propagate one or more synchronized versions of the scene graph to the clients;
wherein the sequence of values defines an order to apply the sets of delta information to the scene graph to produce the one or more synchronized versions of the scene graph.

16. The system of claim 15, wherein the data store includes records of at least some of the one or more synchronized versions of the scene graph, and the records represent deltas between the one or more synchronized versions of the scene graph.

17. The system of claim 15, wherein at least some of the values of the sequence of values reference at least some of the synchronized versions of the scene graph stored in the data store.

18. The system of claim 15, wherein node identifiers reference structural elements of at least some of the one or more synchronized versions of the scene graph stored in the data store.

19. The system of claim 15, wherein the order to apply the sets of delta information is based on an order the sets of delta information are received by the communications manager.

20. The system of claim 15, wherein the scene graph is of a layer of layers of scene graphs that are composed using a ranking of the layers to generate a composite scene graph that defines the three dimensional (3D) virtual environment.
